(19) United States
(12) Patent Application Publication
(10) Pub. No.: US 2011/0078666 A1
(43) Pub. Date: Mar. 31, 2011

(54) System and Method for Reproducing Device Program Execution

(75) Inventor: Gautam Altekar, Mountain View, CA (US)

(73) Assignee: University of California, Berkeley, CA (US)

(21) Appl. No.: 12/788,233

(22) Filed: May 26, 2010

Related U.S. Application Data
(60) Provisional application No. 61/181,214, filed on May 26, 2009.

(51) Int. Cl. G06F 9/44

(52) U.S. Cl. 717/131

(57) ABSTRACT

Provided are a system and method for precisely reproducing a device program execution, such as reproducing a software program executed on a computer for example. The method provides a solution to a class of diagnosis methods known as “record/replay” or “deterministic replay”, where information related to a program execution is recorded for later replay, often for diagnostic purposes to reproduce errors in device function such as software bugs and other anomalous behavior. In contrast with other methods in this class, the invention provides a method for low-overhead recording and high-precision replay of programs possibly utilizing multiple processor cores, and also low-overhead recording and high-precision replay of programs that perform input and/or output operations at high data rates, and further provides a system and method provide a solution with substantially few hardware requirements beyond that of a modern electronic device, such as a personal computer, or a laptop computer, or other electronic device controlled by one or more processors. Taken together, these features enable efficient and cost-effective execution replay of modern multiprocessor and networked software.

### BACKGROUND

Debugging is a complicated and difficult task, but debugging production datacenter applications such as Cassandra, Hadoop, and Hypertable is downright daunting. One major obstacle is non-deterministic failures, or program misbehaviors that are immune to traditional cyclic-debugging techniques and that are difficult to reproduce. Datacenter applications are rife with such failures because they operate in highly non-deterministic environments. A typical setup employs thousands of nodes, spread across multiple datacenters, to process multiple terabytes of data per day. In these environments, existing methods for debugging non-deterministic failures are of limited use. They either incur excessive production overheads or don't scale to multi-node, terabyte-scale processing.

The past decade has seen the rise of large scale, distributed, data-intensive applications such as HDFS/GFS, HBase/Bigtable, and Hadoop/MapReduce. These applications run on thousands of nodes, spread across multiple datacenters, and process terabytes of data per day. Companies such as Facebook, Google, and Yahoo! for example already use these systems to process their massive data-sets. But an ever-growing user population and the ensuing need for new and more scalable services will require novel applications that do not meet current needs.

Unfortunately, debugging programs is a tedious task that has impeded the development of existing and new large scale distributed applications. A key obstacle is non-deterministic failures-hard-to-reproduce program misbehaviors that are immune to traditional cyclic-debugging techniques. These failures often manifest only in production runs and may take weeks to fully diagnose, hence draining the resources that could otherwise be devoted to developing novel features and services.

Developers presently use a range of methods for debugging non-deterministic failures. But they all fall short of current needs in the datacenter environment. The widely-used approach of code instrumentation and logging requires either extensive instrumentation or foresight of the failure to be effective—neither of which are realistic in web-scale systems subject to unexpected production workloads. Automated testing, simulation, and source-code analysis tools can find the errors underlying several non-deterministic failures before they occur, but the large state-spaces of datacenter systems hamper complete and/or precise results. Some errors will inevitably fall through to production. Finally, automated console-log analysis tools show promise in detecting anomalous events and diagnosing failures, but the inferences they draw are fundamentally limited by the fidelity of developer-instrumented console logs.

Computer software often fails. These failures, due to software errors, manifest in the form of crashes, corrupt data, or service interruption. To understand and ultimately prevent failures, developers employ cyclic debugging—they re-execute the program several times in an effort to zero-in on the root cause. Non-deterministic failures, however, are immune to this debugging technique. That is because they may not occur in a re-execution of the program.

Non-deterministic failures can be reproduced using deterministic replay (or record-replay) technology. Deterministic replay works by first capturing data from non-deterministic sources, such as the keyboard and network, and then substituting the same data in subsequent re-executions of the program. Many replay systems have been built over the years, and the resulting experience indicates that replay is very valuable in finding and reasoning about failures.

The ideal record-replay system has three key properties. Foremost, it produces a high-fidelity replica of the original program execution, thereby enabling cyclic debugging of non-deterministic failures. Second, it incurs low recording overhead, which in turn enables in-production operation and ensures minimal execution perturbation. Third, it supports parallel software running on commodity multiprocessors. However, despite decades of research, the ideal replay system still remains out of reach.

One obstacle to building the ideal system is data-races. These sources of non-determinism are prevalent in modern software. Some are errors, but many are intentional. In either case, the ideal-replay system must reproduce them if it is to provide high-fidelity replay. Some replay systems reproduce races by recording their outcomes, but they incur high recording overheads in the process. Other systems achieve low record overhead, but rely on non-standard hardware. Still others assume data-race freedom, but fail to reliably reproduce failures.

Thus effective tools for debugging non-deterministic failures in production datacenter systems are needed in art.

### BRIEF DESCRIPTION OF THE DRAWINGS

FIG. 1 is a diagrammatic view of a system configured according to the invention.

FIG. 2 is a diagrammatic view of a system configured according to the invention.

FIGS. 3A-3D illustrate various flow charts according to the invention.

FIGS. 4A-4E illustrate various flow charts according to the invention.

FIG. 5 shows a chart of logging rates.

FIG. 6 shows a chart of record runtime.

FIG. 7 shows a chart of Debugger Response Time.

FIG. 8 is a diagrammatic view of a system configured according to the invention.

FIG. 9 shows a chart of design space.

FIG. 10 shows a system of Search intensive NVI flow.

FIG. 11 shows another system of Search intensive NVI flow.

FIG. 12 shows another system of Search intensive NVI flow.

FIG. 13 shows a system of composite Prime NVI flow.

FIG. 14 shows another system of composite NVI flow.

FIG. 15 shows a chart of runtime overheads.

FIG. 16 shows a chart of processor login rates.

FIG. 17 shows a chart of inferenceruntime overheads.

FIG. 18 shows a chart of processor replay runtime overheads.

Tables 1-9 illustrate various metrics related to embodiments of the invention.

### DETAILED DESCRIPTION

To overcome the shortcomings of the prior art, a novel replay debugging tool and system are provided, Data Center Replay (DCR), enables the reproduction and debugging of non-deterministic failures in production datacenter runs. The key observation behind DCR is that debugging does not always require a precise replica of the original datacenter run. Instead, it often suffices to produce some run that exhibits the original behaviors of the control-plane—the most error-prone component of datacenter applications. DCR leverages this observation to relax the determinism guarantees offered by the system, and consequently, to address all desired requirements of production datacenter applications, including for example lightweight recording of long-running programs, causally consistent replay of large scale systems, and out of the box operation on real-world applications.

In one embodiment, replay-debugging technology (a.k.a, deterministic replay) can be used to effectively debug non-deterministic failures in production datacenters. Such a replay-debugger works by first capturing data from non-deterministic data sources such as the keyboard and network, and then substituting the captured data into subsequent re-executions of the same program. These replay runs may then be analyzed using conventional tracing tools (e.g., GDB and DTrace) or more sophisticated automated analyses (e.g., race and memory-leak detection, global predicates, and causality tracing).

Many replay debugging systems have been built over the years and experience indicates that they are invaluable in reasoning about non-deterministic failures. However, existing systems typically do not meet the unique demands of the datacenter environment.

One desire of datacenters is always-on operation. Here, the system must be on at all times during production so that arbitrary segments of production runs may be replay-debugged at a later time. In a datacenter, supporting always-on operation is difficult. The system should have minimal impact on production throughput (less than 2% is often cited). But most importantly, the system should log no faster than traditional console logging on terabyte-quantity workloads (100 KBps max). This means that it should not log all non-determinism, and in particular, all disk and network traffic. The ensuing logging rates, amounting to petabytes/week across all datacenter nodes, not only incur throughput losses, but also call for additional storage infrastructure (e.g., another petabyte-scale distributed file system).

Another desire of datacenters is whole-system replay. Here, the system should be able to replay-debug all nodes in the distributed system, if desired, after a failure is observed. Providing whole-system replay-debugging is challenging because datacenter nodes are often inaccessible at the time a user wants to initiate a replay session. Node failures, network partitions, and unforeseen maintenance are usually to blame, but without the recorded information on those nodes, replay-debugging cannot be provided.

Yet another desire of datacenters is out-of-the-box use. The system should record and replay arbitrary user-level applications on modern commodity hardware with no administrator or developer effort. This means that it should not require special hardware, languages, or source-code analysis and modifications. The commodity hardware requirement is essential because we want to replay existing datacenter systems as well as futuresystems¹. Special languages and source-code modifications (e.g., custom APIs and annotations, as used in R2) are undesirable because they are cumbersome to learn, maintain, and retrofit onto existing datacenter applications. Source-code analysis (e.g., as done in ESD and SherLog) is also prohibitive due to the extensive use of dynamically generated (i.e., JITed) code and dynamically linked libraries. For instance, the Hotspot JVM, used by HDFS, Hadoop, HBase, and Cassandra, employs dynamic compilation.

To meet some or all of the aforementioned desires or requirements of datacenters, a DCR—a Data Center Replay system that records and replays production runs of datacenter systems like Cloudstore, HDFS, Hadoop, HBase, and Hypertable. DCR may leverage different techniques, including for example control-plan determinism, distributed interference, just-in-time debugging, and other matters.

Regarding control-plane determinism, the key observation behind DCR is that, for debugging, a precise replica of the original production run is not needed. Instead, it often suffices to produce some run that exhibits the original run's control-plane behavior. The control-plane of a datacenter system is the code responsible for managing or controlling the flow of data through a distributed system. An example is the code for locating and placing blocks in a distributed file system.

The control plane tends to be complicated—it often consists of millions of lines of source code, and thus serves as the breeding ground for bugs in datacenter software. But at the same time, the control-plane often operates at very low data-rates. Hence, by relaxing the determinism guarantees to control-plane determinism, DCR circumvents the need to record most inputs, and consequently achieves low record overheads with tolerable sacrifices of replay fidelity.

Regarding distributed inference, the central challenge in building DCR is that of reproducing the control-plane behavior of a datacenter application without knowledge of its original data-plane inputs. This is challenging because the control-plane's behavior depends on the data-plane's behavior. An HDFS client's decision to look up a block in another HDFS data-node (a control plane behavior) depends on whether or not the block it received passed checksum verification (a data-plane behavior).

To address this challenge, in one embodiment, DCR employs Distributed Deterministic-Run Inference (DDRI)—the distributed extension of an offline inference mechanism we developed in previous work to compute data-plane inputs consistent with the recorded control-plane input/output behavior of the original run. Once inferred, DCR then substitutes the data-plane inputs along with the recorded control-plane inputs into subsequent program runs to generate a control-plane deterministic run.

Regarding just-in-time debugging, though DCR is the first debugger to generate a relaxed deterministic replay session for datacenter applications, it is not the first to leverage the concept of an offline compute phase. Unfortunately, this compute phase may take exponential time to finish in these predecessor systems. A large path space and NP-hard constraints are usually to blame. Regardless, a debugging session cannot be started until this phase is complete. By contrast, DCR can start a debugging session in time polynomial with the length of the original run.

The novel DCR process achieves a low time-till-debug through the use of Just-In-Time DDRI (JIT-DDRI)—an optimized version of DDRI that avoids reasoning about an entire run (an expensive proposition) before replay can begin. The key observation underlying JIT-DDRI is that developers are often interested in reasoning about only a small portion of the replay run—a stack trace here or a variable inspection there. For such usage patterns, it makes little sense to infer the concrete values of all execution states. For debugging then, it suffices to infer, in an on-demand manner, the values for just those portions of state that interest the user.

### OVERVIEW

One central observation behind embodiments DCR is that, for debugging datacenter applications, we do not need a precise replica of the original run. Rather, it generally suffices to reproduce some run that exhibits the original control-plane behavior.

The control-plane of a datacenter application is the code that manages or controls data-flow. Examples of control-plane operations are locating a particular block in a distributed filesystem, maintaining replica consistency in a meta-data server, or updating routing table entries in a software router. Control-plane operations tend to be complicated—they account for over 90% of the newly-written code in datacenter software and serve, not surprisingly, as breeding-grounds for distributed race-condition bugs. On the other hand, the control-plane is responsible for only 5% of all datacenter traffic.

A corollary observation is that datacenter debugging rarely requires reproducing the same data-plane behavior. The data-plane of a datacenter application is the code that processes the data. Examples include code that computes the checksum of an HDFS filesystem block or code that searches for a string as part of a MapReduce job. In contrast with the control-plane, data-plane operations tend to be simple—they account for under 10% of the code in a datacenter application and are often part of well-tested libraries. Yet, the data-plane is responsible for generating and processing 95% of datacenter traffic.

### 2.2 Approach: Control-Plane Determinism

The complex yet low data-rate of the control-plane motivates DCR's approach of relaxing its determinism guarantees. Specifically, DCR aims for control-plane determinism—a guarantee that replay runs will exhibit identical control-plane behavior to that of the original run. Control-plane determinism enables datacenter replay because it circumvents the need to record data-plane communications (which have high data-rates), thereby allowing DCR to efficiently record and replay all nodes in the system.

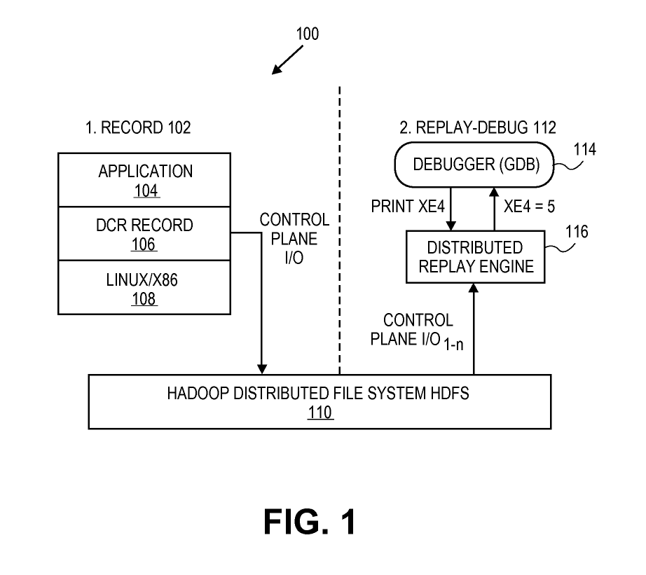

FIG. 1 shows the architecture of one embodiment of a control-plane deterministic replay-debugging system 100. In the record mode 102, application code 104, a DCR record 106 and a Linux x86 processor are employed. In the Reply model 12, the debugger (GDB) 114 sends Print x@4 to and receive x@4=5 from the distributed replay engine 116. From the Hadoop Distributed File System (HDFS) 110, Control Plane I/O₁₋ₙ, is transmitted to the Distributed Replay Engine 116, which receives Control Plane I/O from the record mode 102. Like most replay systems, it may operate in two phases, record mode 102 and replay-debug mode 112. Regarding record mode, DCR records control-plane inputs and outputs (I/O) for all production CPUs (and hence nodes) in the distributed system. Control-plane I/O refers to any inter-CPU communication performed by control-plane code. This communication may be between CPUs on different nodes (e.g., via sockets) or between CPUs on the same node (e.g., via shared memory). DCR streams the control-plane I/O to a Hadoop Filesystem (HDFS) cluster—a highly available distributed data-store designed for datacenter operation—using Chukwa.

Regarding replay-debug mode, to replay-debug her application, an operator or developer interfaces with DCR's Distributed-Replay Engine (DRE). The DRE leverages the previously recorded control-plane I/O to provide the operator with a causally-consistent, control-plane deterministic view of the original distributed execution. The operator interfaces with the DRE using a distributed variant of GDB (see the Friday replay system). Like GDB, the debugger supports inspection of local state (e.g., variables, backtraces). But unlike GDB, it provides support for distributed breakpoints and global predicates—facilities that enable global invariant checking.

### 3 DESIGN

For system designers, the key challenges of efficiently recording and replaying datacenter applications may be overcome by embodiments described herein.

### 3.1 Recording Control Plane I/O

To record control-plane I/O, DCR must first identify it. Unfortunately, such identification generally requires a deep understanding of program semantics, and in particular, whether or not the I/O emanates from control-plane code. Rather than rely on the developer to annotate and hence understand the nuances of sophisticated systems software, in one embodiment, DCR aims for automatic identification of control-plane I/O. The observation behind DCR's identification method is that control and data plane I/O generally flow on distinct communication channels, and that each type of channel has a distinct signature. DCR leverages this observation to interpose on communication channels and then record the transactions (i.e., reads and writes) of only those channels that are classified as control-plane channels.

Of course, any classification of program semantics based on observed behavior will likely be imperfect. Nevertheless, our experimental results show that, in practice, our techniques provide a tight over-approximation—enough to eliminate developer burden and be considered useful.

### 3.1.1 Interposing on Channels

DCR interposes on commonly-used inter-CPU communication channels, regardless of whether these channels connect CPUs on the same node or on different nodes. The channels considered not only include explicitly defined channels such as sockets, pipes, tty, and file I/O, but also implicitly defined channels such as message header channels (e.g., the first 32 bytes of every message) and shared memory.

Socket, pipe, tty, and file channels are the easiest to interpose efficiently as they operate through well-defined interfaces (system calls). Interpositioning is then a matter of intercepting these system calls, keying the channel on the file-descriptor used in the system call (e.g., as specified in sys_read( ) and sys_write( ), and observing channel behavior via system call return values.

Shared memory channels are the hardest to interpose efficiently. The key challenge is in detecting sharing; that is, when a value written by one CPU is later read by another CPU. A naive approach would be to maintain per memory-location meta-data about CPU-access behavior. But this is expensive, as it would require intercepting every load and store. One could improve performance by considering accesses to only shared pages. But this too incurs high overhead in multi-threaded applications (i.e., most datacenter applications) where the address-space is shared.

To efficiently detect inter-CPU sharing, DCR employs the page-based Concurrent-Read Exclusive-Write (CREW) memory sharing protocol, first suggested in the context of deterministic replay by Instant Replay and later implemented and refined by SMP-ReVirt. Page-based CREW leverages page-protection hardware found in modern MMUs to detect concurrent and conflicting accesses to shared pages. When a shared page comes into conflict, CREW then forces the conflicting CPUs to access the page one at a time, effectively simulating a synchronized communication channel through the shared page.

Page-based CREW in the context of deterministic replay has been well-documented by the SMP-ReVirt system and those skilled in the art will readily understand them, the details are omitted here. However, it is noteed that DCR's use of CREW differs from that of SMP-ReVirt's in two major ways. First, rather than record the ordering of accesses, DCR records the content of each access (assuming the access is to the control-plane). Second, DCR is interested only in user-level sharing (it's a user-level replay system), so false-sharing in the kernel (e.g., due to spinlocks) isn't an issue for us (false-sharing at user space is, though; see the discussion below for details on how this is addressed).

### 3.1.2 Classifying Channels

As a simple heuristic, DCR uses the channel's data-rate to identify its type. That is, if the channel data-rate exceeds a threshold, then DCR deems it a data-plane channel and stops recording it. If not, then DCR treats it as a control-plane channel and records it. The control-plane threshold for a channel is chosen using a token bucket algorithm. That is, it is dynamically computed such that aggregate thresholds of all channels do not exceed the per-node logging rate (100 KBps in our trials). This simple scheme is effective because control-plane channels, though bursty, generally operate at low data-rates.

Socket, pipe, tty, and file channels. The data-rates on these channels are measured in bytes per second. DCR measures these rates by keeping track of the number of bytes transferred (as indicated by sys_read( ) return values) over time. A simple moving average is maintained over a t-second window, where t=2 by default.

Shared-memory channels. The data-rates here are measured in terms of CREW-fault rate. The higher the fault rate, the greater the amount of sharing through that page. DCR collects the page-fault rate by updating a counter on each CREW fault, and maintaining a moving average of a 1 second window. DCR caps the per-node control-plane threshold for shared memory channels at 10K faults/sec. A larger cap can incur slowdowns beyond 20% (see below for the impact of CREW fault-rate on run time).

Though effective in practice, the heuristic of using CREW page-fault rate to detect control-plane shared-memory communication can lead to false negatives. In particular, the behavior of legitimate but high data-rate control-plane activity (e.g., spin-locks) will not be captured, hence precluding control-plane determinism of the communicating code. In practical experiments, however, such false negatives were rare due to the fact that user-level applications (especially those that use pthreads) rarely employ busy-waiting. In particular, on a lock miss, pthread_mutex_lock( ) will await notification of lock availability in the kernel rather than spin incessantly.

### Avoiding High CREW Fault-Rates

The CREW protocol, under certain workloads, can incur high page-fault rates than in turn will seriously degrade performance (see SMP-ReVirt). Often this is due to legitimate sharing between CPUs, such as when CPUs contend for a spin-lock. Sometimes, however, the sharing may be false—a consequence of unrelated data-structures being housed on the same page. In such circumstances, CPUs aren't actually communicating on a channel.

Regardless of the cause, DCR employs a simple strategy to avoid high page-fault rates. When DCR observes that the fault-rate threshold for a page is exceeded (i.e., is a data-plane channel), it removes all page protections from that page and subsequently enables unbridled access to it, thereby effectively turning CREW off for that page. CREW is then re-enabled for the page n seconds in the future to determine if data-rates have changed.

### 3.2 Providing Control-Plane Determinism

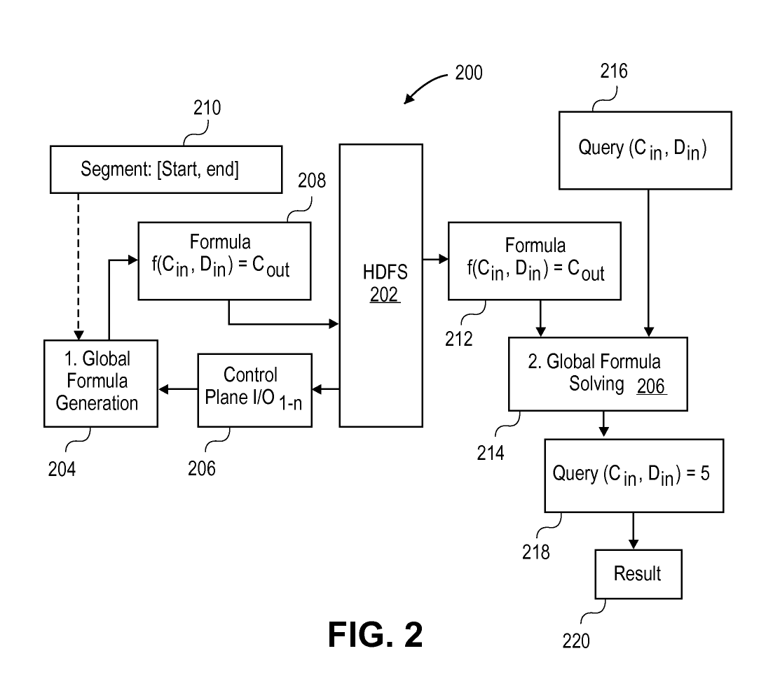

FIG. 2 shows a closer look at DCR's Distributed-Replay Engine (DRE). It employs Distributed Deterministic-Run Inference to provide the debugger with a control-plane deterministic view of distributed state. With the Just-In-Time optimization enabled, the DRE requires an additional query argument (dashed). The central challenge faced by DCR's Distributed Replay Engine (DRE) is that of providing a control-plane deterministic view of program state in response to debugger queries. This is challenging because, although DCR knows the original control-plane inputs, it does not know the original data-plane inputs. Without the data-plane inputs, DCR can't employ the traditional replay technique of re-running the program with the original inputs. Even re-running the program with just the original control-plane inputs is unlikely to yield a control-plane deterministic run, because the behavior of the control-plane depends on the behavior of the data-plane.

To address this challenge, the DRE employs Distributed Deterministic Run Inference (DDRI)—the distributed extension of a single-node inference mechanism previously developed to efficiently record multiprocessor execution (see the ODR replay system). DDRI leverages the original run's control-plane I/O (previously recorded by DCR) and program analysis to compute a control-plane deterministic view of the query-specified program state. DDRI's program analysis operates entirely at the machine-instruction level and does not require annotations or source-code.

Referring to FIG. 2, a DDRI system 200 is illustrated. The system includes HDFS 202 similar to that of FIG. 1, which receives output from Global Formula Generator 204 and sends Control Plane I/O₁₋ₙ 206 from HDFS 202 according to Formula f(Cᵢₙ, Dᵢₙ)=C_{Out} 208. Global Formula Generator 208 optionally receives Segment:[Start, end] 210. The HDFS outputs f(Cᵢₙ, Dᵢₙ)=C_{Out} 212 into Global Formula Solving module 206, which receiveds Query(Cᵢₙ, Dᵢₙ) 216, and outputs Query(Cᵢₙ, Dᵢₙ)=5 218, result 220. DDRI works in two stages. In the first stage, global formula generation, DDRI translates the distributed program into a logical formula that represents the set of all possible distributed, control-plane deterministic runs. Of course, the debugger-query isn't interested in this set. Rather, it is interested in a subset of a node's program state from just one of these runs. So in the second phase, global formula solving, DDRI dispatches the formula to a constraint solver. The solver computes a satisfiable assignment of variables for the unknowns in the formula, thereby instantiating a control-plane deterministic run. From this run, DDRI then extracts and returns the debugger-requested execution state.

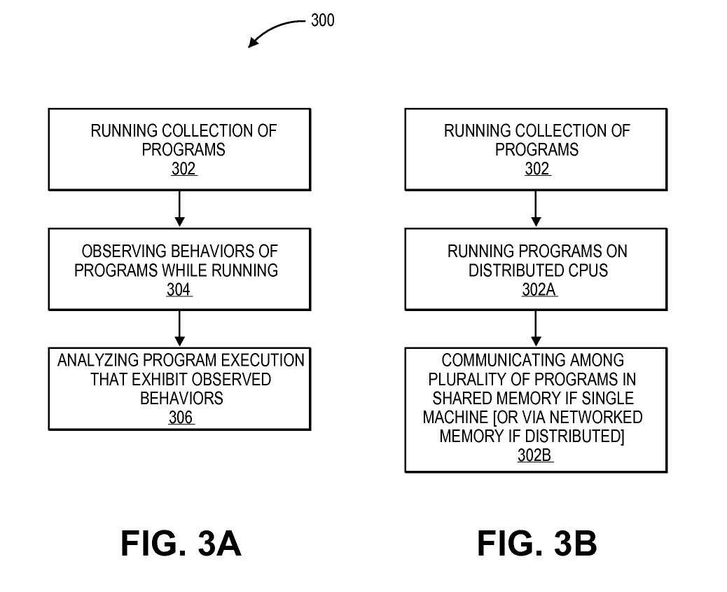

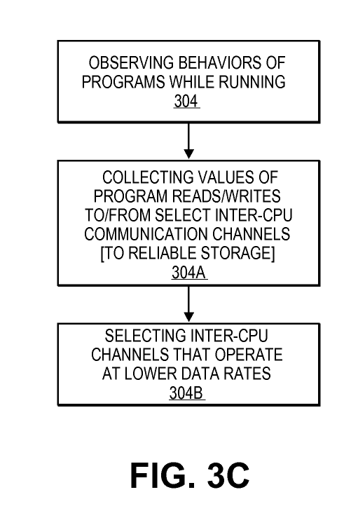

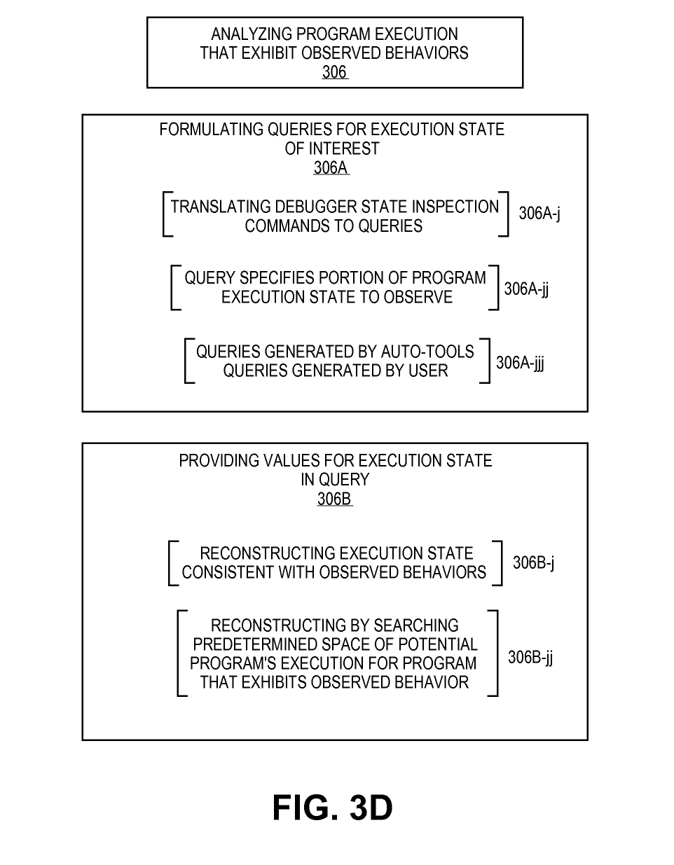

Referring to FIG. 3A, a method 300 for Data Center Replay (DCR) is illustrated, including running a collection of programs 302, observing the behaviors of the programs while they are running 304, and analyzing programs' executions that exhibit the observed behaviors 306. Referring to FIG. 3B, more detail of running a collection of programs 302 includes running individual programs on distributed CPUs 302a, wherein distributed CPUs may be on the same machine or spread across multiple machines, wherein programs may communicate through shared memory if on the same machine or the network if on different machines 302b.

Referring to FIG. 3C, observing program behaviors 304 includes collecting the values of program reads and writes from/to select inter-cpu communication channels 304a, that further includes inter-cpu channels that include shared memory, console, network (e.g., sockets), inter-process (e.g., pipes), and file channels wherein select inter-cpu channels include those that operate at low data rates, or those designated by the user as having low data rates. Wherein collecting includes recording the data values to reliable storage 304b.

FIG. 3D shows a method of analyzing execution(s) consistent with the observed behaviors 306 that includes formulating queries for execution state of interest 306a, that includes options 306A-i-iii, wherein formulating queries includes translating debugger state inspection commands to queries, wherein query specifies portion of program execution state to observe, wherein query includes those queries automatically generated by analysis tools as well as those generated by a person. The method further includes providing values for execution state specified in the query 306b, that includes options 306b i-ii, wherein values are provided by reconstructing execution state consistent with the observed behavior, wherein reconstructing state values comprises of searching a predetermined space of potential programs' executions for one that exhibits the observed behavior, and wherein searching includes using symbolic reasoning to infer program state of target execution. wherein the symbolic reasoning includes reasoning done on demand in response to queries, wherein the on demand reasoning includes doing only the work necessary to answer queries, wherein the symbolic reasoning includes reasoning done with the aid of an automated symbolic reasoning program (e.g., constraint solver or theorem prover), wherein the predetermined space of potential executions includes only those executions that exhibit the observed behaviors extracting specified state values, inspecting returned execution state, wherein inspecting includes checking return state for program invariant violations, data races, memory leaks, or causality anomalies.

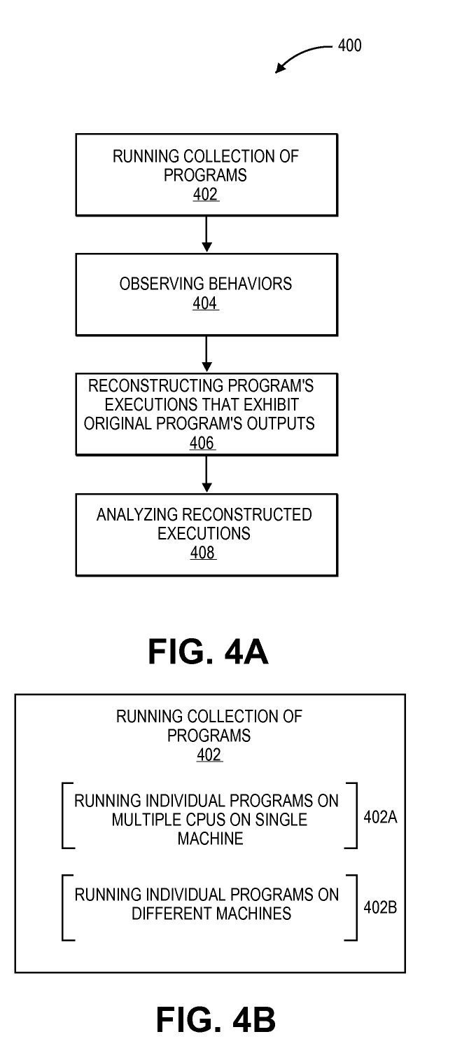

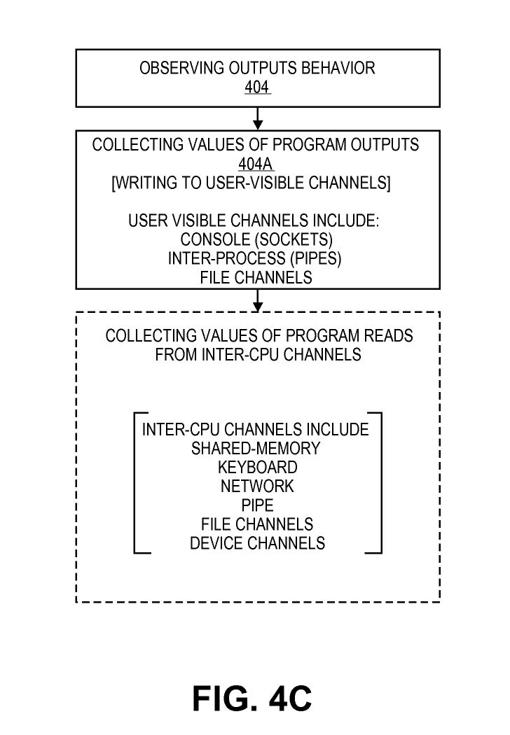

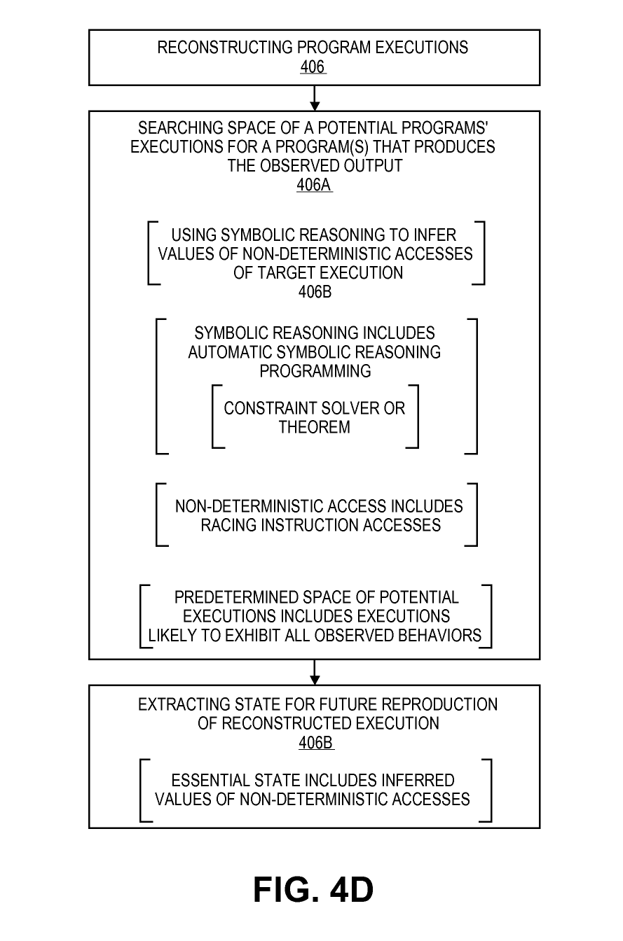

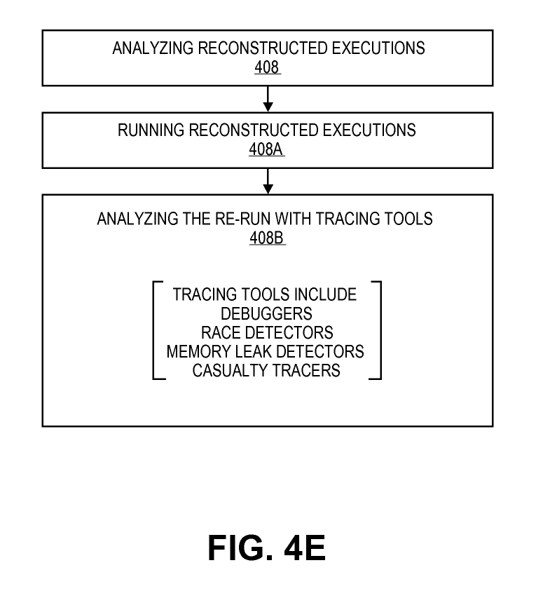

Referring to FIG. 4A, a method 400 for reproducing electronic multi-program execution is illustrated that includes running a collection of programs 402, observing behaviors of the programs while they are running 404, reconstructing programs' executions that exhibit the original executions' outputs 406, and analyzing the reconstructed executions 408.

Referring to FIG. 4B, a method according to Claim 18, wherein running a collection of programs is illustrated that includes running individual programs on different CPUs on the same machine. Referring to FIG. 4C, a method of observing outputs and other program behaviors 404 includes collecting the values of program outputs (i.e., writes to user-visible channels); and wherein user-visible channels includes the console, network (e.g., sockets), inter-process (e.g., pipes), and file channels optionally includes collecting the values of program reads from inter-cpu channels wherein inter-cpu channels include shared-memory, keyboard, network, pipe, file, and device channels

Referring to FIG. 4D, method of reconstructing program executions 406 includes searching a predetermined space of potential programs' executions for one that produces the observed output, and options 46B including wherein searching includes using symbolic reasoning to infer values of non-deterministic accesses of target execution, wherein the symbolic reasoning includes reasoning done with the aid of an automated symbolic reasoning program (e.g., constraint solver or theorem prover), wherein the non-deterministic accesses include those of racing instruction accesses, wherein the predetermined space of potential executions includes only those executions likely to exhibit the observed output behaviors, wherein executions likely to exhibit the observed output behaviors includes those executions that exhibit all observed behaviors extracting essential state for the future reproduction of the reconstructed execution, wherein essential state includes the inferred values of non-deterministic accesses.

FIG. 4E shows a method according to Claim 18, where the analyzing of the reconstructed program's behaviors 408 that includes re-running the reconstructed executions 408A and analyzing the re-run with tracing tools 408B, wherein tracing tools include debuggers, race detectors, memory leak detectors, and causality tracers.

### 3.2.1 Global Formula Generation

Generating a single formula that captures the behavior of a large scale datacenter system is hard, for two key reasons. First, a datacenter system may be composed of thousands of CPUs, and the formula must capture all of their behaviors. Second, the behavior of any given CPU in the system may depend on the behavior of other CPUs. Thus the formula needs to capture the collective behavior of the system so that inferences that are made from the formula are causally consistent across CPUs.

To capture the behavior of multiple, distributed CPUs, DCR generates a local formula for each CPU. A local formula for CPU i, denoted as Lᵢ(Cinᵢ,Dinᵢ)=Coutᵢ, represents the set of all control-plane deterministic runs for that CPU, independent of the behavior of all other CPUs. DCR knows the control-plane I/O (Cinᵢ and Coutᵢ) of all CPUs, so the only unknowns in the formula are the CPU's data-plane inputs (Dinᵢ). Local formula generation is distributed on available nodes in the cluster and is described in further detail below.

To capture the collective behavior of distributed CPUs, DCR binds the per-CPU local formulas (Lᵢ's) into a final global formula G. The binding is done by taking the logical conjunction of all local formulas and a global causality condition. The global causality condition is a set of constraints that requires any message received by a CPU to have a corresponding and preceding send event on another CPU, hence ensuring that inferences made from the formula are causally consistent across nodes. In short, G=L₀ [symbol] [symbol] Lₙ [symbol] C, where C is the global causality condition.

### 3.2.2 Global Formula Solving

In theory, DDRI could send the generated global formula, in its entirety, to a lone constraint solver. However, in practice, this strategy is doomed to fail as modern constraint solvers are incapable of solving the multi-terabyte formulas and NP-hard constraints produced by sophisticated and long-running datacenter applications. How this challenge is addressed is discussed below.

3.2.3 Local Formula Generation

DDRI translates a program into a local-formula using Floyd-style verification condition generation. The DDRI generator most resembles the generator employed by Proof-Carrying Code (PCC) in that it works by symbolically executing the program at the instruction level, and produces a formula representing execution along multiple program paths. However, because the PCC and DDRI generators address different problems, they differ in the following ways:

Conditional and indirect jumps. Upon reaching a jump, the PCC generator will conceptually fork and continue symbolic execution along all possible successors in the control-flow graph. But when the jump is conditional or indirect, this strategy may yield formulas that are exponential in the size of the program.

By contrast, the DDRI generator considers only those successors implied by the recorded control-plane I/O. This means that when dealing with control-plane code, DDRI is able to narrow the number of considered successors down to one. Of course, the jump may be data-plane dependent (e.g., data-block checksumming code). In that case, multiple static paths must still be considered.

Loops. At some point, symbolic execution will encounter a jump that it has seen before. Here PCC stops symbolically executing along that path and instead relies on developer-provided loop-invariant annotations to summarize all possible loop iterations, hence avoiding “path explosion”.

Rather than rely on annotations, DDRI sacrifices precision: it unrolls the loop a small but fixed number of times (similar to the unrolling done by ESC-Java) and then uses Engler's underconstrained execution to fast-forward to the end of the loop. The number of unrolls is computed as the minimum of 100 and the number of iterations to the next recorded system event (e.g., syscall) as determined by its branch count. Unrolling the loop effectively offloads the work of finding the right dynamic path through the loop to the constraint solver, hence avoiding path explosion during the generation phase (the solving phase is still susceptible, but see below).

Indirect accesses (e.g., pointers). Dereferences of symbolic pointers may access one of many locations. To reason about this precisely, PCC models memory as a symbolic array, hence offloading alias analysis to the constraint solver. Though such offloading can scale with PCC's use of annotations, DDRI's annotation free requirement results in an intolerable burden on the constraint solver.

Rather than model all of memory as an array, DDRI models only those pages that may have been accessed in the original run by the symbolic dereference. DDRI knows what those pages are because DCR recorded their IDs in the original run using conventional page-protection techniques. In some instances, the number of potentially touched pages is large, in which case DDRI sacrifices soundness for the sake of efficiency: it considers only the subset of potentially touched pages referenced by the past k direct accesses.

### 3.3 Scaling Debugger Response Time

A primary goal of DCR is to provide responsive and interactive replay-debugging. But to achieve this goal, DCR's inference method (DDRI—the post-run inference method introduced in Section 3.2) must surmount major scalability challenges.

### 3.3.1 Huge Formulas, NP-Hard Constraints

Modern constraint solvers cannot directly solve DDRI-generated formulas, for two reasons. First, the formula may be terabytes in size. This is not surprising as DDRI must reason about long-running data-processing code that handles terabytes of unrecorded data. Second, and more fundamentally, the generated formulas may contain NP-hard constraints. This too is not surprising as datacenter applications often invoke cryptographic routines (e.g., Hypertable uses MD5 to name internal files).

Just-in-Time Inference. To overcome this challenge, we've developed Just-In-Time DDRI (JIT-DDRI)—an on-demand variant of DDRI that enables responsive inference-based debugging of datacenter applications. The observation underlying JIT-DDRI is that, when debugging, developers observe only a portion of the execution—a variable inspection here or a stack trace there. Rarely do they inspect all program states. This observation then implies that there is no need to solve the entire formula, as that corresponds to the entire execution. Instead, it suffices to solve just those parts of the formula that correspond to developer interest.

FIG. 2 (dashed and solid) illustrates the DDRI architecture with the JIT optimization enabled. JIT DDRI accepts an execution segment of interest and state expression from the debugger. The segment specifies a time range of the original run and can be derived by manually inspecting console logs. JIT DDRI then outputs a concrete value corresponding to the specified state for the given execution segment.

JIT DDRI works in two phases that are similar to non-JIT DDRI. But unlike non-JIT DDRI, each stage uses the information in the debugger query to make more targeted inferences:

JIT Global Formula Generation. In this phase, JIT-DDRI generates a formula that corresponds only to the execution segment indicated by the debugger query.

The unique challenge faced by JIT FormGen is in starting the symbolic execution at the segment start point rather than at the start of program execution. To elaborate, the symbolic state at the segment start point is unknown because DDRI did not symbolically execute the program before that. The JIT Formula Generator addresses this challenge by initializing all state (memory and registers) with fresh symbolic variables before starting symbolic execution, thus employing Engler's under-constrained execution technique.

For debugging purposes, under-constrained execution has its tradeoffs. First, the inferred execution segments may not be possible in a real execution of the program. Second, even if the segments are realistic, the inferred concrete state may be causally inconsistent with events (control-plane or otherwise) before the specified starting point. This could be especially problematic if the root-cause being chased originated before the specified starting point. It has been found that, in practice, these relaxation are of little consequence so long as DCR reproduces the original control plane behavior.

JIT Global Formula Solving. In this phase, JIT-DDRI solves only the portion of the previously generated formula that corresponds to the variables (i.e., memory locations) specified in the query.

The main challenge here is to identify the constraints that must be solved to obtain a concrete value for the memory location. This is done in two steps. First, in one embodiment, the memory location is resolved to a symbolic variable, and then the symbolic variable is resolved to a set of constraints in the formula. The first resolution is performed by looking up the symbolic state at the query point (this state was recorded in the formula generation phase). Then for the second resolution, we employ a connected components algorithm to find all constraints related to the symbolic variable. Connected components take time linear in the size of the formula.

### 3.3.2 Distributed System Causality

A replay-debugger is of limited use if it doesn't let the developer backtrack the chain of causality from the failure to its root cause. But ensuring causality in inferred datacenter runs is hard: it requires efficiently reasoning about communications spanning thousands of CPUs, possibly spread across thousands of nodes. JIT-DDRI can help with such reasoning by solving only those constraints involved in the chain of causality of interest to the developer. However, if the causal chain is long, then even JIT-DDRI-produced constraints may be overwhelmingly large for the solver.

Inter-Node Causality Relaxation. To overcome this challenge, DCR enables the user to limit the degree d of inter-node causality that it reasons about—a technique previously employed by the ODR system to scale multi-processor inference. Specifically, if d is set to 0, then DCR does not guarantee any data-plane causality. That is, an inferred run may exhibit data-plane values received on one node that were never sent by another node. On the other hand, if d is set to 2, for instance, then DCR provides data-plane values consistent across two node hops. After the third hop, causal relationships to previously traversed nodes may not be discernible.

The appropriate value of d depends on the system and error being debugged. It is observed that, in many cases, reasoning about inter-node data-plane causality is altogether dispensable (i.e., d=0). For example, figuring out why a lookup went to slave node 1 rather than slave node 2 requires tracing the causal path of the lookup request (a control-plane entity), but not that of the data being transferred to and from the slave nodes. In other cases, data-plane causality is needed—for example, to trace the source of data corruption to the underlying control-plane error on another node. It has been found that if the data corruption has a short propagation distance, then d≦3 often suffices (see the case study herein for an example in which d had to be at least 2).

### 4 IMPLEMENTATION

DCR currently runs on Linux/x86. It consists of 120 KLOC of code (95% C, 3% ASM). 70 KLOC is due to the LibVEX binary translator. We developed the other 50 KLOC over a period of 8 person-years. Here is presented a selection of the implementation challenges faced.

### 4.1 Sample Usage

With DCR, a user may record and replay-debug a distributed system with a few simple commands. Before starting a production recording, however, DCR is configured first to never exceed a low threshold logging rate:

d0:˜/$ dcr-conf Sys.MaxRecRate=100 KBps

Next the user may start a recording session. Here Hypertable is started (a distributed database) on three production nodes under the “demo” session name:

p0:˜/$ dcr-rec -s “demo” ht-lock-man
p1:˜/$ dcr-rec -s “demo” ht-master
p2:˜/$ dcr-rec -s “demo” ht-slave

Before initiating a replay debugging session, DCR's session manager is used to first identify the set of nodes that is desired to replay debug:

d0:˜/$ dcr-sm --info “demo”

Session “demo” has 3 node(s):

[0] p0 ht-lock-man 10 m
[1] p1 ht-master 32 m
[2] p2 ht-slave 11 m

The output shows that though the master node ran for 32 minutes, the lock-manager and slave terminated early at about 10 minutes into execution. Areplay-debugging session is begun for just the early terminating nodes near the time they terminated:

d0:~/$ dcr-gdb --time 9m:12m
--nodes 0,2 “demo”
gdb> backtrace node 0
#1 <segmentation fault>
#2 LockManager::handle_message( ):52

The output shows that node 0 terminated due to a segmentation fault, hence probably bringing down the slave sometime thereafter.

### 4.2 User-Level Architecture

DCR may be designed to work entirely at user-level for several reasons. First, a tool is desired that works with and without VMs. After all, many important datacenter environments do not use VMs. Secondly, it is desired that the implementation to be as simple as possible. VM-level operation would require that the DRE reason about kernel behavior as well—a hard thing to get right. Moreover it avoids semantic gap issues. Finally, it was observed that interposing on control-plane channels to be efficient. Specifically, Linux's vsyscall page was used to avoid traps. A high CREW fault rate was avoided due to false-sharing in the kernel.

Implementing the CREW protocol at user-level presented some challenges, primarily because Linux doesn't permit per-thread page protections (i.e., all threads share a page-table). This means that we protections cannot be turned off for a thread executing on one CPU while enable its for a thread running on a different CPU. This problem is addressed by extending each process's page table (by modifying the kernel) with per-CPU page-protection flags. When a thread gets scheduled in to a CPU, then it uses the protections for the corresponding CPU.

### 4.3 Formula Generation

DDRI generates a formula by symbolically executing the target program (see Section 3.2.3), in manner very similar to that of the Catchconv symbolic execution tool. Specifically, symbolic execution proceeds at the machine instruction level with the aid of the LibVEX binary translation library. VEX translates x86 into a RISC-style intermediate language once basic block at a time. DDRI then translates each statement in the basic block to an STP constraint.

DCR's symbolic executor borrows several tricks from prior systems. An important optimization is constraint elimination, in which constraints for those instructions not tainted by symbolic inputs (e.g., data-plane inputs) are skipped.

### 4.4 Debugger Interface

DCR's debugger enables the developer to inspect program state on any node in the system. It is implemented as a Python script that multiplexes per-node GDB sessions on to a single developer console, much like the console debugger of the Friday distributed replay system. With the aid of GDB, our debugger currently support four primitives: backtracing, variable inspection, breakpoints, and execution resume. Watchpoints and state modification are currently unsupported.

Getting DCR's debugger to work was hard because GDB doesn't know how to interface with the DRE. That is, unlike classical replay mechanisms, the DRE doesn't actually replay the application; it merely infers specified program state. However, the key observation made is that GDB inspects child state through the sys_ptrace system call. This leads to DCR's approach of intercepting GDB's ptrace calls and translating them into queries that the DRE can understand. When the DRE provides an answer (i.e., a concrete value) to DCR, it then returns that value to GDB through the ptrace call.

### 5 EVALUATION

Here presented is the experimental evaluation of DCR.

### 5.1 Performance

Below is a comparative evaluation of DCR's performance. A fair comparison, however, is difficult because substantially no other publicly available, user-level replay system is capable of deterministically replaying the datacenter applications in the suite. Rather than compare apples with oranges, the comparison is based on a modified version of DCR, called BASE, that records both control and data plane non-determinism in a fashion most similar to SMP-ReVirt—the state of the art in classical multi-core deterministic replay.

In short, it was found that DCR incurs very low recording overheads suitable for at least brief periods of production use (a 16% average slowdown and 8 GB/day log rates). Moreover, it was found that DCR's debugger response times, though sluggish, are generally fast enough to be useful. By contrast, BASE provides extremely responsive debugging sessions as would be expected of a classical replay system. But it incurs impractically high record-mode overheads (over 50% slowdown and 3 TB/day log rates) on datacenter-like workloads.

### 5.1.1 Setup

Applications. In one embodiment, DCR is based on two real-world datacenter applications: Cloudstore and Hyptertable.

Cloudstore is a distributed filesystem written in 40K lines of multithreaded C/C++ code. It consists of 3 sub-programs: the master server, slave server, and the client. The master program consists mostly of control-plane code: it maintains a mapping from files to locations and responds to file lookup requests from clients. The slaves and clients have some control-plane code, but mostly engage in control plane activities: the slaves store and serve the contents of the files to and from clients.

Hypertable is a distributed database written in 40K lines of multithreaded C/C++ code. It consists of 4 key sub-programs: the master server, metadata server, slave server, and client. The master and metadata servers are largely control-plane in nature—they coordinate the placement and distribution of database tables. The slaves store and serve the contents of tables placed there by clients, often without the involvement of the master or the metadata server. The slaves and clients are thus largely data-plane entities.

Workloads and Testbed. The workloads were chosen to mimic peak datacenter operation and to finish in 20 minutes. Specifically, for Hypertable, 8 clients performed concurrent lookups and deletions to a 1 terabyte table of web data. Hypertable was configured to use 1 master server, 1 meta-data server, and 4 slave servers. For Cloudstore, we made 8 clients concurrently get and put 100 gigabyte files. We used 1 master server and 4 slave servers.

All applications were run on a 10 node cluster connected via Gigabit Ethernet. Each VM in our cluster operates at 2.0 GHz and has 4 GB of RAM. The OS used was Debian 5 with a 32-bit 2.6.29 Linux kernel. The kernel was patched to support DCR's interpositioning hooks. Our experimental procedure consisted of a warmup run followed by 6 trials. We report the average numbers of these 6 trials. The standard deviation of the trials was within three percent.

### 5.1.2 Recording Overheads

### Logging Rates.

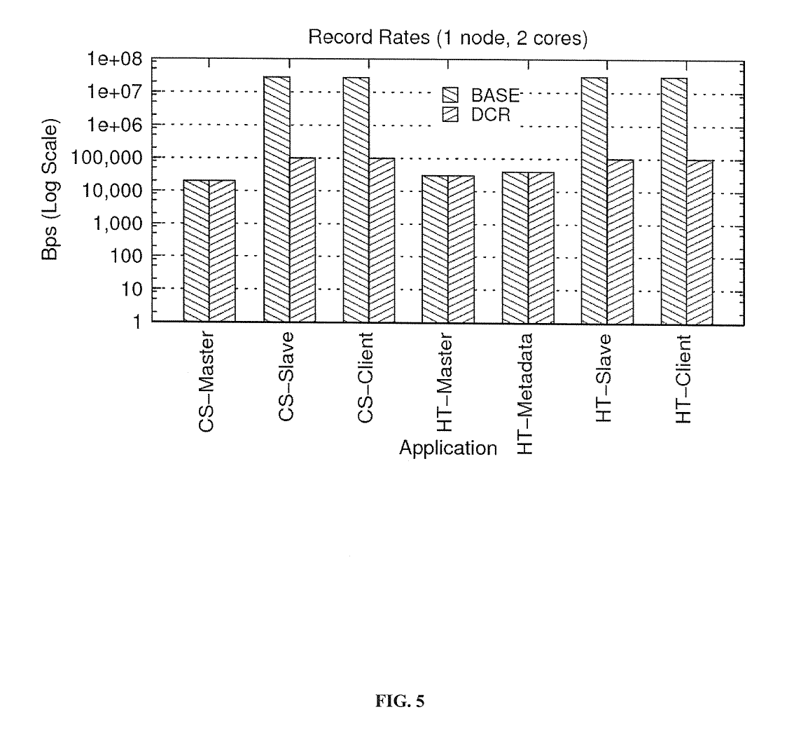

FIG. 5 gives results for the record rate, a key performance metric for datacenter workloads. It shows that, across all applications, DCR's log rates are suitable for the datacenter—they're less than those of traditional console logs (100 KBps) and up to two orders of magnitude lower than BASE's rates (3 TB/day v. 8 GB/day). This result is not surprising because, unlike BASE, DCR does not record data-plane I/O. Record runtimes, normalized with native application execution time, for (1) BASE which records control and data planes and (2) DCR which records just the control plane. DCR's performance is up to 60% better.

A key detail is that DCR outperforms BASE for only data-intensive programs such as the Hypertable slave nodes; control-plane dominant programs such as the Hypertable master node perform equally well on both. This makes sense, as data intensive programs routinely exceed DCR's 100 KBps logging rate threshold and are capped. The control-plane dominant programs never exceed this threshold, and thus all of their I/O is recorded.

### Slowdown.

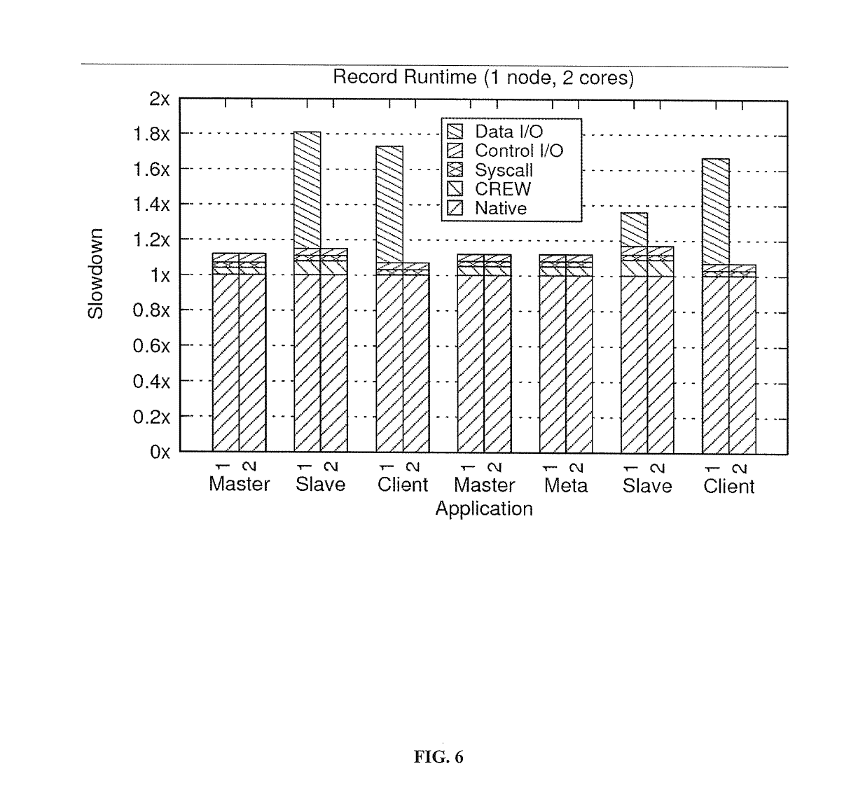

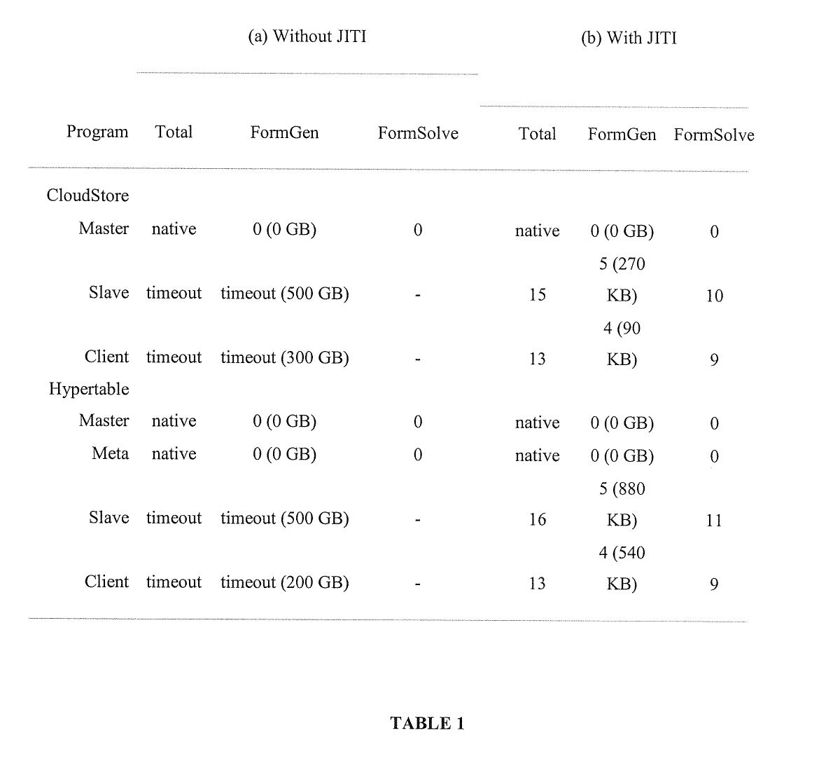

FIG. 6 gives the slowdown incurred by DCR broken down by various instrumentation costs. At about 17%, DCR's record-mode slowdown is as much as 65% less than BASE's. Since DCR records just the control-plane, it doesn't have to compete for disk bandwidth with the application as BASE must. The effect is most prominent for disk intensive applications such as the CloudStore slave and Hypertable client. Overall, the DCR's slowdowns on data-intensive workloads are similar to those of classical replay systems on data-unintensive workloads. Mean per-query debugger latencies in seconds broken down into formula generation (FormGen) and solving time (FormSolve). Formula generation (FormGen) times out at 1 hour. The key result is that data-unintensive applications exhibit low latencies regardless of whether JITI is used or not, but data-intenstive applications require JITI to avoid query timeouts.

DCR's slowdowns are greater than our goal of 2%. The main bottleneck is shared-memory channel interpositioning, with CREW faults largely to blame—the Hypertable range servers can fault up to 8K times per second. The page fault rate can be reduced by lowering the default control-plane threshold of 10K faults/sec. DCR would then be more willing to deem high data-rate pages as part of the data-plane and stop intercepting accesses to them. But the penalty is more work for the inference mechanism.

### 5.1.3 Replay-Debugging Latency

Despite a formidable inference task, DCR's JIT debugger enables surprisingly responsive replay-debugging of real datacenter applications. To show this, we evaluate DCR's replay-debugging latency under two configurations: without and with Just-in-Time Inference (JITI) enabled. Table 1.

For both configurations, we obtained the debugger latency using a script that simulates a manual replay-debugging session. The script makes 10K queries for state from the first 10 minutes of the replayed distributed execution. The queries are focused on exactly one node and may ask the debugger to print a backtrace, return a variable's value (chosen from the stack context indicated by the backtrace), or step forward n instructions on that node. Queries that take longer than 20 seconds are timed out

Impact of Just-in-Time Inference. FIG. 6 gives the average debugger latency, with and without the JITI optimization, for our application suite. It conveys two key results.

First, DCR provides native debugger latencies for data-unintensive nodes (e.g., the Hypertable and CloudStore master nodes), regardless of whether JITI is enabled or not. Data-unintensive nodes operate below the control-plane threshold data rate, hence enabling DCR to efficiently record all transactions on those channels. Since all information is recorded, there is no need to infer it and hence no need to generate a formula and solve it—hence the 0 formula sizes and solving times. The result is that, as with traditional replay systems, the user may begin replay debugging data-plane unintensive nodes immediately.

Second, DCR has surprisingly fast latencies for queries of data-intensive programs (e.g., Hypertable and CloudStore slaves), but only if JITI is enabled. Data-intensive programs operate above the control-plane threshold data rate and thus DCR does not record most of their I/O. The resulting inference task, however, is insurmountable without JITI, because a mammoth formula (often over 500 GBs) must be generated and solved. By contrast, JITI also produces large formulas. But these formulas are smaller (around 30 GBs) and are subsequently split into multiple smaller sub-formulas (500 KB on average) that can be solved fairly quickly (10 seconds on average).

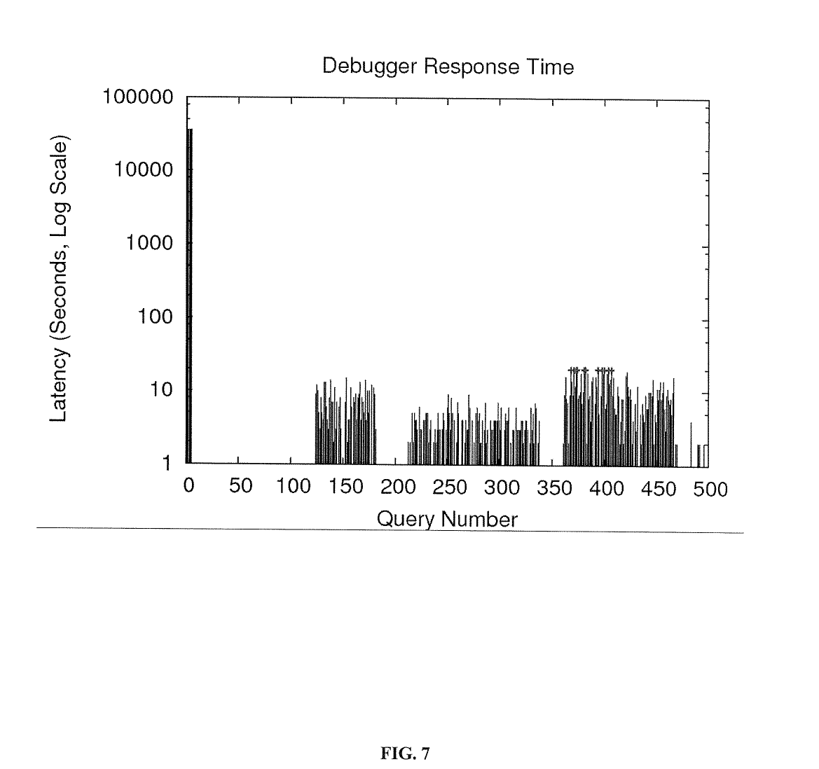

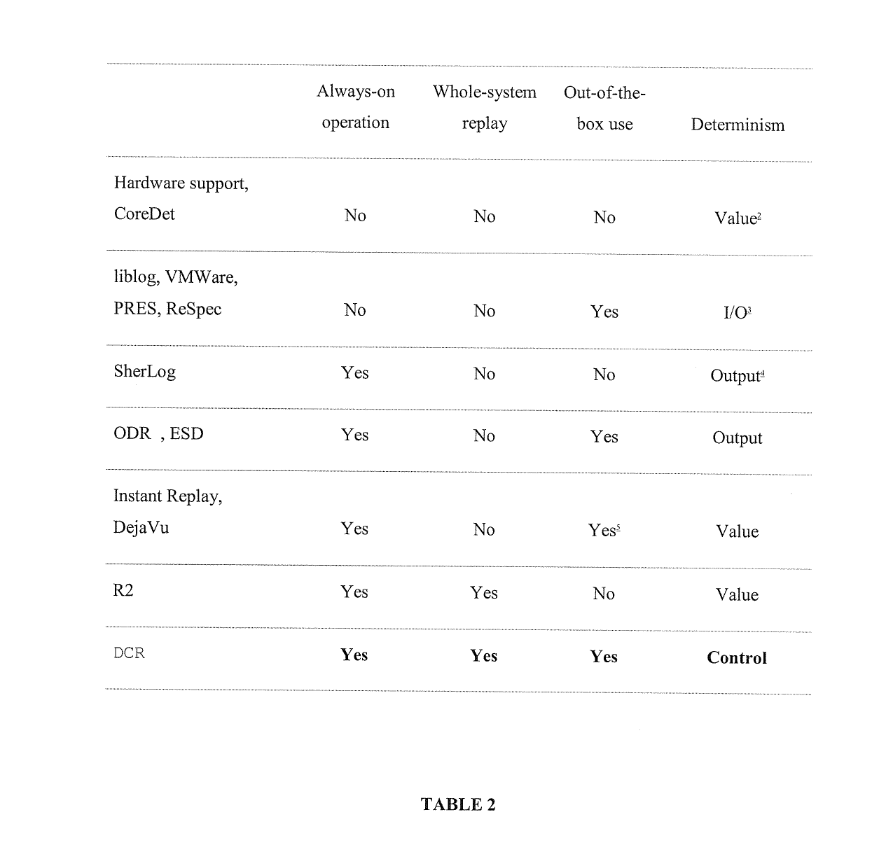

User Experience. DCR's mean response time with JITI, though considerably better than without JITI, is still sluggish. Should the user expect every JITI query to take so long? The debugger latency profile given for a Hypertable slave node in FIG. 7 answers this question in the negative. Debugger query latency profile for a Hypertable slave server. The first query is really slow, but subsequents ones are generally much faster. Red dots denote queries that timed out at 20 seconds. Specifically, it makes two points.

First, the slowest query by far is the very first query—it takes 10 hours to complete. This makes sense because the first query induces the replay engine to generate a multi-gigabyte formula and split it in preparation for Just-in-Time Inference. Though both of these operations take time linear in the length of the execution segment being debugged, they are slow when they have to process gigabytes of data.

The second key result is that non-initial queries are generally fast, with the exception of a few timeouts due to hard constraints (2% of queries). The speed is attributed to three factors.

First, results of the formula generation and splitting done in the first query are cached and reused in subsequent queries, hence precluding the need to symbolically execute and split the formula with each new query. Second, many queries are directed at concrete state (usually to control-plane state). These queries do not require constraint solving. Finally, if a query is directed at data-plane state, then DCR's debugger (with JITI) solves only the sub-formula corresponding to the queried state (see above). These sub-formulas are generally small and simple enough (on the order of hundreds of KBs, see above) to provide 8-12 second response times.

### 5.2 Case Study

Here we report our experience using DCR to debug a real-world non-deterministic failure. We offer this experience not as conclusive evidence of DCR's utility—a difficult task given the variable amount of domain knowledge the developer brings to the debugging process—but as a sampling of the potential that DCR may fulfill with further study.

### 5.2.1 Setup

We focus our study on Hypertable issue 63—a critical defect entitled “Dropped Updates Under Concurrent Loading”. Recent versions of Hypertable do not exhibit the issue, as it was fixed long ago. So we reverted to an older version that did exhibit the issue.

Failure. Updates to a database table are lost when multiple Hypertable clients concurrently load rows into the same table. The load operation appears to be a success—clients nor the slaves receiving the updates produce error messages. However, subsequent dumps of the table don't return all rows; several thousand are missing.

Root Cause. In short, the data loss results from rows being committed to slave nodes (a.k.a, Hypertable range servers) that are not responsible for hosting them. The slaves honor subsequent requests for table dumps, but do not include the mistakenly committed keys in the dumped data. The committed keys are merely ignored.

The erroneous commits stem from a race condition in which row ranges migrate to other slave nodes while a recently received row within the migrated range is being committed to the current slave node. Instead of aborting the commit for the row and forwarding it to the newly designated data node along with other rows in the migrated range, the data node allows the commit to proceed.

Several observations were made in the development of several embodiments, and some of these are set forth here.

Data-plane causality is sometimes necessary. It was desired to know whether it was possible to debug this failure without data-plane causality, so the debugger was initially set with d=0 (see above). Surprisingly, our initial attempt to reproduce the failure was a success—it was observed that several previously submitted updates were indeed missing. But when it was tried to backtrack from the client to the sending slave node, it was found that the sent updates had no correspondence with the received updates, making further backtracing difficult.

By contrast, the same experiment with d set to 2 yielded causally consistent results. It was then possible comfortably backtrack the dumped key to the client that initially submitted it. The penalty for reasoning about inter-node causality, however, was a 10-fold increase in JIT debugger latency.

Data-plane determinism is dispensable. It was desired to reason about updates dropped in the original using the replay execution, as would be possible in a traditional replay system. But this was challenging, because there was no discernible correspondence between the original lost updates and the inferred lost updates. This was clear in retrospect, because the value of the updates did not need to be any particular string for the underlying error to be triggered, DCR inferred an arbitrary string that happened to differ from that of the original.

This challenge was overcome by ignoring the originally dropped updates. Instead, the experiment focused on tracing the dropped updates in the inferred replay run. Because the underlying error was a control-plane defect, the discrepancies in key values between the original and the inferred mattered little in terms of isolating the root cause. Both exercised the same defective code.

### 5.2.3 Debugging in Detail

We isolated the root cause with a series of distributed invariant checks, each performed with the use of a global predicate.

### Check 1: Received and Committed?

Predicate. Were all keys in the update successfully received and committed by the range servers? To answer this question, we created a global predicate that fires when any of the keys sent by a client fails to commit on the server end.

Result. The global predicate did not fire, hence indicating that all keys were indeed received and committed by their respective nodes.

Predicate operation. During replay, the predicate maintains a global mapping from each key sent by a client to the range server that committed the key. If all sent keys do not obtain a mapping by the end of execution, then the predicate fires.

To obtain the mapping, the predicate places two distributed breakpoints. The first breakpoint is placed on the client side RangeLocator: set(key) function, which is invoked every time a key is sent to a range server. When triggered, our predicate inserts the corresponding key into the map with a null value. The second breakpoint was set on the slave side RangeServer: update(key) function, which is invoked right before a key is committed. When triggered, the predicate inserts the committing node's id as the value for the respective key.

### Check 2: Committed to the Right Place?

Predicate. The keys were committed, but were they committed to the right slave nodes? To find out, we created a global predicate that fires when a key is committed to the “wrong” node. The committing node is wrong if it is not the node responsible for hosting the key, as indicated by Hypertable's global key-range to node-id table (known as the METADATA table).

Result. Partly through the execution our global predicate fired for row-key x. It fired because, although key x lies in a range that should be hosted by node 2, it was actually committed to node 1. Thus, some form of METADATA inconsistency is to blame.

Predicate operation. The predicate maintains two global mappings and fires when they mismatch. The first mapping maps from key-ranges to the node id responsible for hosting those key-ranges, as indicated by the METADATA table. The second maps each sent key to its committing node's id.

To obtain the first mapping, the predicate intercepts all updates to the METADATA table. This was done by placing a distributed breakpoint on the TableMutator: set(key, value) function. When the breakpoint fires and if this references a METADATA table, we then map key to value.

To obtain the second mapping, the predicate places a distributed breakpoint at the callsite of Range::add(key) within the RangeServer::update(key) function. When it fires, the predicate maps key to the committing node id.

### Check 3: A Stale Mapping to Blame?

Predicate. We know that, before committing a key, a range server first checks that it is indeed responsible for the key's range. If not, the read/update is rejected. But Part 2 showed that the key is committed even after the range server's self check. Could it be the case that the node assignment for the committing key changed in between the range server's self check and commit? To find out, we created a global predicate that fires when a key's node assignment changes in the time between the self-check and commit.

Result. The predicate fired. The cause was a concurrent migration of the key range (known as a split) fielded by another thread on the same node. It turns out that range-servers split their key-ranges, offloading half of it to another range-server, when the table gets too large.

Predicate operation. This predicate maintains three mappings: (1) from keys to node ids at the time of the self check, (2) from keys to node ids at the time of commit, and (3) from keys to METADATA change events made in between the self check and commit. The predicate fires when there is an inconsistency between the first and the second.

To obtain the first and second mappings, we placed a breakpoint on calls to TableInfo::find_containing_range(key) and Range::add(key), respectively. find_containing_range( ) checks that the key should be committed on this node and add( ) commits the row to the local store. When either of these breakpoints fire, the predicate adds a mapping from the key to the node id hosting that key. The predicate obtains the node id by monitoring changes to the METADATA table in the same manner as done in Part 2.

To obtain the third mapping, the predicate places a breakpoint on calls to TableMutator::set(key), where the table being mutated is the metadata table.

### 6 RELATED WORK

FIG. 7 compares DCR with other replay-debugging systems along key dimensions. The following paragraphs explain why existing systems do not meet our requirements. Refer to Table 2.

Always-On Operation. Classical replay systems such as Instant Replay, liblog, VMWare, and SMP-ReVirt are capable of, or may be easily adapted for, large-scale distributed operation. Nevertheless, they are unsuitable for the datacenter because they record all inbound disk and network traffic. The ensuing logging rates, amounting to petabytes/week across all datacenter nodes, not only incur throughput losses, but also call for additional storage infrastructure (e.g., another petabyte-scale DFS).

Several relaxed-deterministic replay systems (e.g., Stone, PRES, and ReSpec) and hardware and/or compiler assisted systems (e.g., Capo, Lee et al., DMP, CoreDet, etc.) support efficient recording of multi-core, shared-memory intensive programs. But like classical systems, these schemes still incur high record-rates on network and disk intensive distributed systems (i.e., datacenter systems).

Whole-System Replay. Several replay systems can provide whole-system replay for small clusters, but not for large-scale, failure-prone datacenters. Specifically, systems such as liblog, Friday, VMWare, Capo, PRES, and ReSpec allow an arbitrary subset of nodes to be replayed, but only if recorded state on that subset is accessible. Order-based systems such as DejaVu and MPIWiz may not be able to provide even partial-system replay in the event of node failure, because nodes rely on message senders to regenerate inbound messages during replay.

Recent output-deterministic replay systems such as ODR (our prior work), ESD, and SherLog can efficiently replay some single-node applications (ESD more so than the others). But these systems were not designed for distributed operation, much less datacenter applications. Indeed, even single-node replay is a struggle for these systems. On long-running and sophisticated datacenter applications (e.g., JVM-based applications), they require reasoning about an exponential number of program paths, not to mention NP-hard computations, before a replay-debugging session can begin.

Out-of-the-Box Use. Several replay schemes employ hardware support for efficient multiprocessor recording. These schemes don't address the problem of efficient datacenter recording, however. What's more, they currently exist only in simulation, so they don't meet our commodity hardware requirement.

Single-node, software-based systems such as CoreDet, ESD, and SherLog employ C source code analyses to speed the inference process. However, applying such analyses in the presence of dynamic code generation and linking is still an open problem. Unfortunately, many datacenter applications run within the JVM, well-known for dynamically generating code.

The R2 system provides an API and annotation mechanism by which developers may select the application code that is recorded and replayed. Conceivably, the mechanism may be used to record just control-plane code, thus incurring low recording overheads. Alas, such annotations are hardly “out of the box”. They require considerable developer effort to manually identify the control-plane and to retrofit existing code bases.

### 7 CONCLUSION

We have presented DCR, a replay debugging system for datacenter applications. We believe DCR is the first to provide always-on operation, whole distributed system replay, and out of the box operation. The key idea behind DCR is control-plane determinism—the notion that it suffices to reproduce the behavior of the control plane—the most error-prone component of the datacenter app. Coupled with Just-In-Time Inference, DCR enables practical replay-debugging of large-scale, data-intensive distributed systems.

In another embodiment, an ODR—a software-only replay system is presented that reproduces bugs and provides low-overhead multiprocessor recording. The key observation behind ODR is that, for debugging purposes, a replay system does not need to generate a high-fidelity replica of the original execution. Instead, it suffices to produce any execution that exhibits the same outputs as the original. Guided by this observation, ODR relaxes its fidelity guarantees, and thus avoids the problem of reproducing data-races all-together. The result is an Output-Deterministic Replay system that replays real multiprocessor applications, such as Apache and the Java Virtual Machine, and, in one experiment, provides a factor of up to 8 or more improvement in recording overheads over comparable systems.

Computer software often fails. These failures, due to software errors, manifest in the form of crashes, corrupt data, or service interruption. To understand and ultimately prevent failures, developers employ cyclic debugging—they re-execute the program several times in an effort to zero-in on the root cause. Non-deterministic failures, however, are immune to this debugging technique. That's because they may not occur in a re-execution of the program.

Non-deterministic failures can be reproduced using deterministic replay (or record-replay) technology. Deterministic replay works by first capturing data from non-deterministic sources, such as the keyboard and network, and then substituting the same data in subsequent re-executions of the program. Many replay systems have been built over the years, and the resulting experience indicates that replay is very valuable in finding and reasoning about failures [4].

The ideal record-replay system has three key properties. Foremost, it produces a high-fidelity replica of the original program execution, thereby enabling cyclic debugging of non-deterministic failures. Second, it incurs low recording overhead, which in turn enables in-production operation and ensures minimal execution perturbation. Third, it supports parallel software running on commodity multiprocessors. However, despite decades of research, the ideal replay system still remains out of reach.

A chief obstacle to building the ideal system is data-races. These sources of non-determinism are prevalent in modern software. Some are errors, but many are intentional. In either case, the ideal-replay system must reproduce them if it is to provide high-fidelity replay. Some replay systems reproduce races by recording their outcomes, but they incur high recording overheads in the process. Other systems achieve low record overhead, but rely on non-standard hardware. Still others assume data-race freedom, but fail to reliably reproduce failures.

In this paper, we present ODR—a software-only replay system that reliably reproduces failures and provides low-overhead multiprocessor recording. The key observation behind ODR is that a high-fidelity replay execution, though sufficient, is not necessary for replay-debugging. Instead, it suffices to produce any execution that exhibits the same output, even if that execution differs from the original. This observation permits ODR to relax its fidelity guarantees and, in so doing, enables it to all-together avoid the problem of reproducing and hence recording data-race outcomes.

The key problem ODR must address is that of reproducing a failed execution without recording the outcomes of data-races. This is challenging because the manifestation of failures depends in part on the outcomes of races. To address this challenge, rather than recording all properties of the original execution, ODR searches the space of executions for one that exhibits the same outputs as the original. Of course, a brute-force search of the execution space is intractable. But carefully selected clues recorded during the original execution allow ODR to home-in on an output-deterministic execution in a practical amount of time.

ODR performs its search using a technique we term non-deterministic value inference, or NVI for short. NVI leverages output collected during the original run and the power of symbolic reasoning to infer the values of non-deterministic access-values. Once inferred, ODR substitutes these values for the corresponding accesses in subsequent program executions. The result is an output-deterministic execution.

Like most replay systems, ODR is not without its limitations (see below). For instance, our inference technique is limited in the kinds of races it can reason about. Nevertheless, we have used ODR to replay production runs of several widely-used applications, including Apache and the Java Virtual Machine—large parallel programs containing many benign data races. Implemented as user-level middleware for Linux/x86, ODR has recording overhead that is, on average, a factor of 8 less than other systems in its class and has comparable logging rates. Finally, while ODR doesn't outperform all multiprocessor replay systems, initial results show much promise in its approach.

### 2 PROBLEM

The problem ODR addresses is first defined and then requirements of one embodiment of a valid solution are specified.

### 2.1 Definition

Traditional replay systems address the problem of reproducing executions. In contrast, ODR addresses the problem of reproducing failures. The two problems, though ostensibly equivalent, are in fact quite distinct. To clarify this distinction, we formally define both problems, starting with preliminary definitions.

Execution determinism. Let [symbol] denote the set of all program execution predicates (e.g., of the form “the branch at instruction count 23 was taken”, “thread 1 wrote to x 1.2 us before thread 2”, etc.).

Then for some P⊂ [symbol] , we say that two executions are P-deterministic if predicate p [symbol] P of one execution holds if and only if p holds in the other.

Determinism generator. Let [symbol] denote the set of all runs for a given program and e [symbol] denote an original run. Then for some P⊂ [symbol] , we say that function G: [symbol] → [symbol] is a P-determinism generator if G(e) and e are P-deterministic.

Execution-replay problem. The execution replay problem is that of building a generator G such that G(e) and e are [symbol] -deterministic.

Failure-replay problem. We define a failure F⊂ [symbol] to be the set of program-dependent execution predicates that describe observable program misbehaviors. Classes of observable misbehaviors are crashes, corrupted data, and unexpected delays. The failure-replay problem is that of building a generator G such that G(e) and e are F-deterministic.

Note that the failure-replay problem is narrower than the execution-replay problem—any solution for the execution-replay problem is a valid failure-replay solution but not vice versa. ODR addresses the failure-replay problem.

### 2.2 Requirements

Any determinism generator that addresses the failure-replay problem should replay failures. But, to be practical, a system that implements such a generator must also meet the following requirements.

Support multiple processors or cores. Multiple cores are a reality in modern commodity machines. A practical replay system should allow applications to take full advantage of those cores.

Replay all programs. A practical tool should be able to replay arbitrary program binaries, including those with data races. Bugs may not be reproduced if the outcomes of these races aren't reproduced.

Support efficient and scalable recording. Production operation is possible only if the system has low overhead. Moreover, this overhead must remain low as the number of processor cores increases.

Require only commodity hardware. A software-only replay method can work in a variety of computing environments. Such wide-applicability is possible only if the system doesn't introduce additional hardware complexity or require unconventional hardware.

### 3 BACKGROUND

As further background, existing replay systems implement value-determinism generators, meaning that the runs they generate load the same values from memory, at the same execution points, as the original run—a property we term value-determinism. As with all value-deterministic runs, all execution variables have the same values as their counterparts in the original run.

Value-determinism generators are unsound solutions to the failure-replay problem because they cannot reproduce all failures. For instance, value-determinism generators cannot precisely reproduce the timing of instructions, due to Heisenberg uncertainty. But despite their unsoundness, value-deterministic runs have proven useful in debugging, because of two key qualities. First, they reproduce program outputs, and hence most operator-visible failures, such as assertion failures, crashes, core dumps, and file corruption. Second, they provide variable values consistent with the failure, hence enabling developers to trace the chain of causality from the failure to its root cause.

Value-determinism generators work by recording and replaying data from the two key sources of non-determinism: program inputs and shared-memory accesses. To record and replay program inputs, they log the values from devices (such as the keyboard, network, and disk) and substitute the recorded values at the same input points in future runs of the program. To record and replay shared-memory accesses, they record either the content or ordering of shared-memory accesses, and then force subsequent runs to return the recorded content or follow the same access ordering, respectively.

Unfortunately, value-determinism generators have met with little success in multiprocessor environments. The key difficulty is in replaying shared-memory accesses while meeting all the requirements given in Section 2.2. For instance, content-based generators can replay arbitrary programs but suffer from extremely high record-mode costs (e.g., 17× slowdown). Order-based generators provide low record-overhead, but only for programs with limited false-sharing or no data-races. Finally, hardware-assisted generators can replay arbitrary programs at very low record-mode costs, but require non-commodity hardware.

### 4 APPROACH

Provided are embodiments of systems and methods configured to employ an output-determinism generator to address the failure-replay problem. An output-determinism generator is any generator that produces output-deterministic runs—those that output the same values as the original run. We define output as program values sent to devices such as the screen, network, or disk. Hence, our definition of output includes the most common types of failures, including error and debug messages, core dumps, and corrupted packets and files.

One embodiment of a method for reproducing electronic program execution includes running a program, collecting output data while the program is running, performing an output deterministic execution, searching a predetermined space of potential executions of the program, and calculating inferences from the collected output data to find operational errors in the program.

In one embodiment, collecting output data includes collecting output data clues indicative of the operation of the program being run. In another embodiment, searching a space of potential executions includes searching the collected output data using symbolic reasoning to infer values of non-deterministic access values.

In another embodiment, a system for reproducing electronic program execution includes a run module configured to run a program, a collection module configured to collect data clues during the running of the program, and an execution program configured to run the program in an output deterministic execution to determine operational errors in the program based on the data clues collected when the program is run in the run module.

Optionally, a collection module is configured to collect output data clues indicative of the operation of the program being run.

The execution module may be configured to search a space of potential executions and includes searching the collected output data using symbolic reasoning to infer values of non-deterministic access values.

All value-determinism generators are output-extremism generators, but not all output-determinism generators are value-determinism generators, that's because an output-deterministic run needn't have the same values as the original run. Output-determinism generator offer weaker determinism guarantees than value-determinism generators. Consequently, they too are unsound solutions to the failure-replay problem.

Despite their weaker guarantees, we argue that output-determinism generators are as effective as value-determinism generators for debugging purposes. This holds for two reasons. First, they reproduce the most important classes of user-visible failures—those that are visible from the output values. Second, they produce variable values that, although may differ from the original values, are nonetheless consistent with the failure. Consistency enables developers to trace the chain of causality from the failure to its root cause.

Our hypothesis is that if we relax the determinism requirements from value to output determinism, then we can build a practical replay system. In particular, by shifting the focus of determinism to outputs rather than values, output-determinism enables us to circumvent the problem of reproducing shared-memory values all-together. The result, as we detail in the following sections, is a record-efficient, software-only multiprocessor replay system.

### 5 OVERVIEW

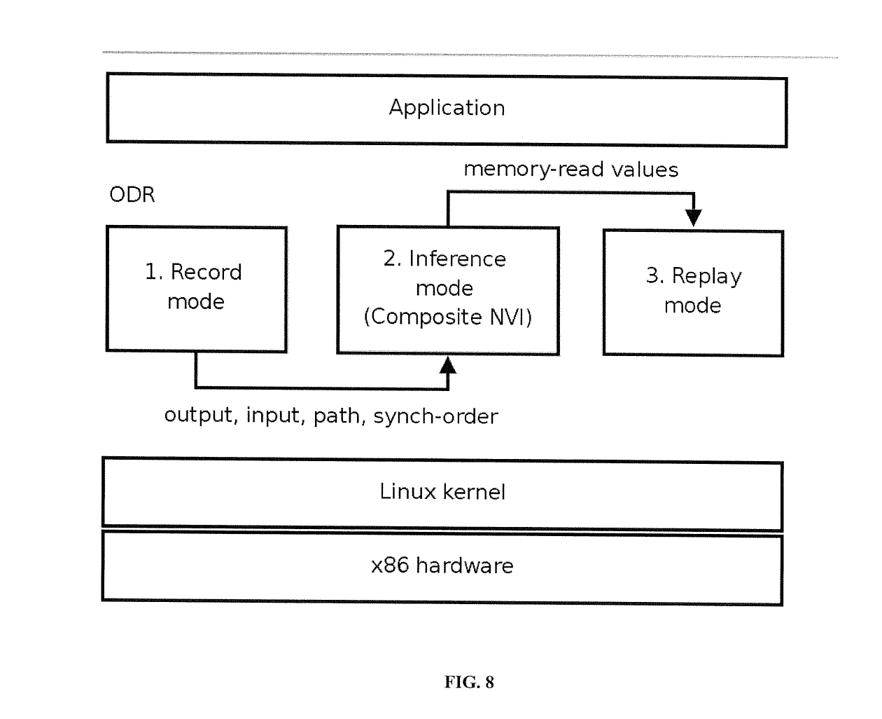

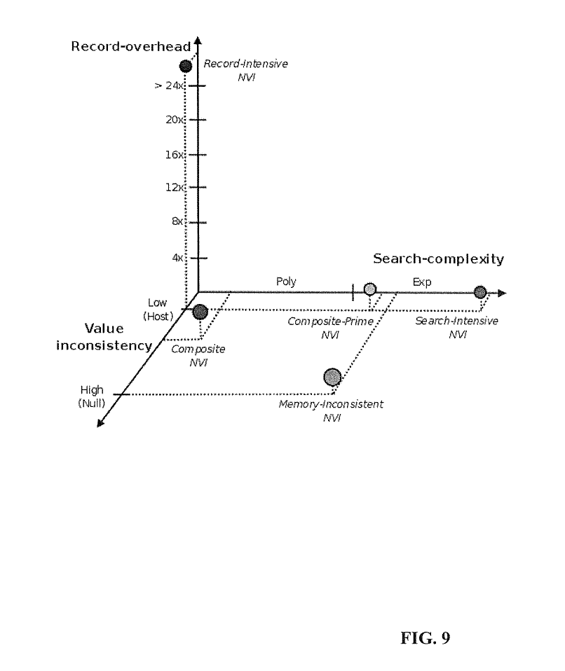

ODR is an output-deterministic replay system. That is, it implements the output-determinism generator introduced herein. Built for Linux/x86, ODR operates largely at user-level and works in three phases, as depicted in the FIG. 8 above. Like other replay systems, it has a recording and a replaying phase. But unlike other replay systems, ODR has an intermediate phase: the inference phase. A bulk of this paper is devoted to the inference phase, but here we introduce all the phases and describe how they fit together.

### 5.1 Record Mode

Multiprocessor execution-replay systems typically record program inputs and the outcomes of shared-memory accesses, for instance, by logging the content or ordering of memory accesses. In contrast, ODR records the outputs, inputs, path, and synchronization-order of the original execution. ODR makes no effort to record the outcomes of shared-memory accesses. ODR records all information using well-known user-level techniques, such as system-call interpositioning and binary translation.

### 5.2 Inference Mode

The central challenge in building ODR is that of reproducing the original output without reproducing the original values. To answer this challenge, ODR employs Non-deterministic Value Inference (NVI)—a novel post-record mode inference technique that returns the non-deterministic memory read values of an output-deterministic run. The returned values include those of program inputs (e.g., keyboard presses, incoming messages, file reads) and shared-memory accesses (e.g., benign and erroroneous races). To infer these non-deterministic values, NVI requires, at a minimum, the outputs of the original run.

### 5.3 Replay Mode

To generate a run that is output indistinguishable from the original, ODR substitutes the read-values computed in the inference phase for the corresponding accesses in subsequent program runs. The computed read-values can be used to reliably and repeatedly reproduce the output, and hence failures, of the original run. Furthermore, replay proceeds at full speed, enabling fast and responsive debugging using GDB, or automated dynamic analyses such as race or memory-leak detection.

### 6 INFERENCE

Non-deterministic Value Inference, like other inference methods, employs search. Specifically, it searches the space of executions and returns the values of nondeterministic accesses in the first output-deterministic execution it finds. An exhaustive search of this space is intractable, so NVI narrows the search by trading off record-mode performance and result quality. In conjunction, these tradeoffs open the door to a previously uncharted inference design space. Here we describe that design space, identify our target within it, and establish a roadmap for reaching that target.

### 6.1 Design Space

There are several variants of NVI, and each occupies a point in the three-dimensional tradeoff space shown in FIG. 9. The first dimension in this space is search-complexity. This dimension specifies how long it takes NVI to find an output deterministic execution. We measure this time at a coarse granularity: exponential or polynomial time.

The second design dimension, record-overhead, captures the slowdown incurred (in normalized runtime) as a result of gathering search clues. All variants of NVI must record, at a minimum, the output of the original run. Additional search clues, such as program inputs or path, may also be recorded, but with additional record-overhead.

The third dimension describes the degree of value-inconsistency in the computed execution. The lowest degree of inconsistency is when memory-access values are consistent with a run on the host machine (e.g., x86 memory model consistency). The greatest degree of inconsistency is when memory-access values make no sense with respect to other access values. The latter is produced in only our hypothetical null-consistency model, where the machine returns arbitrary values for reads.

### 6.2 Design Goal

The ideal NVI variant lays at the origin of FIG. 2—it finds a sequentially-consistent output-deterministic execution in polynomial time with negligible record-overheads. We don't know how to attain this ideal point, so our goal is a more modest point—one with usable record overheads, polynomial search time, and near sequentially-consistent value consistency. We term our target design-point Composite NVI, because it strives for a reasoned compromise between the extreme points of this design space.

### 6.3 Roadmap

In the following sections, we develop Composite NVI in two phases. In the first phase, we explore the extreme points in the NVI tradeoff space. Specifically, we begin with Search-Intensive NVI, a variant of NVI that achieves low record-overhead and high value-consistency, but at the expense of search-efficiency. Then we present Record-Intensive NVI, a method that achieves low search-times and high value-consistency at the expense of record-efficiency. And finally, we describe Memory-Inconsistent NVI, a method that sacrifices value-consistency for low record-overhead and moderate search-times.

In the second phase, we merge these extreme points to form Composite NVI. The merge phase has two sub-steps. In the first, we merge Search-Intensive and Record-Intensive NVI to create Composite-Prime NVI. An in the second step, we merge Composite-Prime NVI with Memory-Inconsistent NVI to finally derive Composite NVI.

### 7 SEARCH-INTENSIVE NVI

Search-Intensive NVI (SI-NVI) requires only that the original run's output be recorded. Given this output, SI-NVI then infers a thread-schedule and a set of program input values for that schedule. The inferred inputs, when substituted in future program runs along the inferred schedule, generate the memory-read values for an output-deterministic execution.

### 7.1 Algorithm

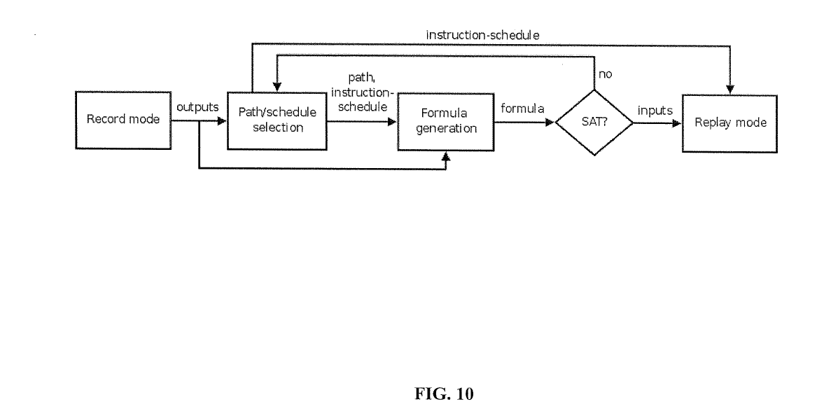

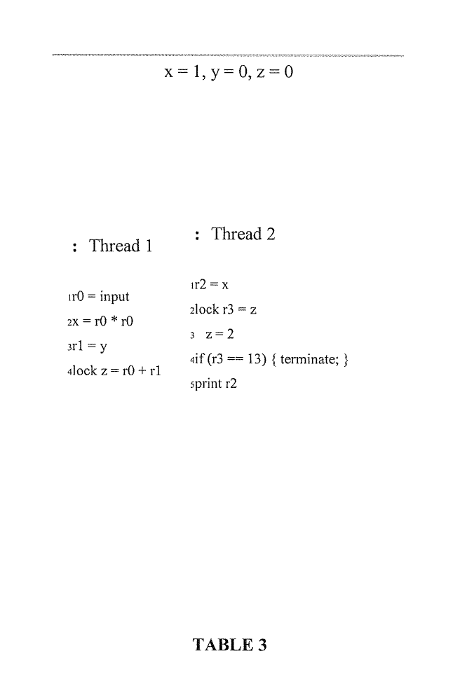

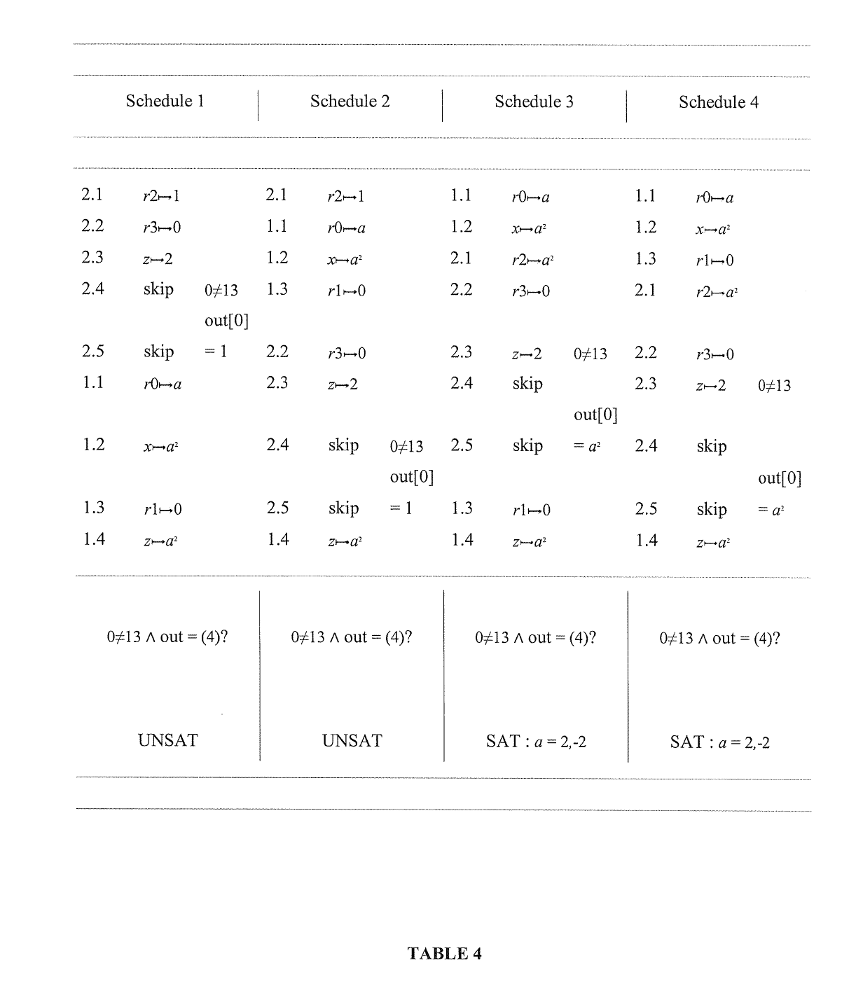

Depicted in FIG. 10, SI-NVI works by searching the space of all program executions. Its search algorithm operates iteratively, where each iteration has three steps. In the first step, path and schedule selection, SI-NVI selects a program path and thread-schedule from the set of all possible paths and schedules. In the second step, formula generation, SI-NVI computes a logical formula that represents the outputs produced along the chosen path and schedule as a function of program inputs. In the final step, formula solving, SI-NVI attempts to find an assignment of inputs in the formula generated in the previous step such that the program output is the recorded output. Search-Intensive NVI searches the space of all executions for one that outputs the same values as the original run. It enables low-overhead recording, but has a search-complexity that is exponential in the number of paths and schedules.

If a satisfying solution is found, then the search terminates; SI-NVI has found a thread-schedule and an assignment of inputs for that schedule that makes the program output the original values. But if a satisfying solution could not be found, then SI-NVI repeats the search along a different path and/or thread-schedule, looping to the first step.

In the next three sections, we present these three steps in detail. Refer to Table 3.

### 7.2 Path and Schedule Selection

Definition 1. Let Tᵢ=(c₁, c₂, . . . , cₙ) be an n-length sequence of instructions executed in program order by thread i, where c denotes a program counter value. Then a path P is the tuple (T₁, T₂, . . . , T_{N}) where N is the number of threads. The code in FIG. 10, for example, has two paths: P₁=((1, 2, 3, 4), (1, 2, 3, 4)) and P₂=((1, 2, 3, 4), (1, 2, 3, 4, 5)).

SI-NVI selects a path using a bounded depth-first search of the path space for each thread. To determine the bound, we assume that the original run outputs the maximum number of branches executed by any thread at the end of its execution. The program's path space then is the cross-product of the path-space of all threads.

Definition 2. An i(instruction)-schedule is a total ordering of instructions in P that respects program-order. We represent instruction-schedules as a sequence of instructions—Table 1 gives several examples for path P₂=(T₁, T₂), where Tᵢ(j) is denoted as i.j.

We select an i-schedule using a depth-first search of the space of all interleavings of chosen path P.

### 7.3 Formula Generation

SI-NVI generates a formula for the chosen path and schedule using symbolic execution, a technique that involves running code on symbolic variables. Symbolic variables represent program inputs and are initially allowed to take on any value; that is, they are unconstrained. As the program executes along the path and schedule, however, additional constraints are learned by observing how symbolic variables influence branch outcomes and outputs. The formula produced by symbolic execution, then, is simply the conjunction of all learned constraints.

Table 4 shows symbolic execution in action on the code in FIG. 10 for several example schedules of path P₂. SI-NVI assigns a new symbolic variable to the destination of each program input, accounting for the fact that the program's output along the selected schedule depends solely on the input. For example, it assigns r0 the symbolic variable a because r0 is the destination of the input on line 1.1. Once an input variable is assigned, SI-NVI track its influence with a symbolic map—a structure that maps program state to symbolic expressions and is updated after each modification to that state. For example, after executing 1.2, SI-NVI assigns x the variable a² because the concrete value of x now depends on the concrete value of a×a.

SI-NVI generates constraints at branch and output instructions. When execution reaches a branch instruction, SI-NVI binds the symbolic branch variable(s) to the outcome predetermined by the path/schedule selection phase. For example, in all the schedules given in Table 1, the branch was chosen to be not-taken (i.e., path P₂), and hence it must hold that 0≠13. When execution reaches an output instruction, SI-NVI takes note of the position of the symbolic variable being outputted in the output stream. We track this with a special symbolic-sequence variable out. For example, in all the schedules given in Table 1, we constrain the first (and only) position of the symbolic output sequence, out[0], to be the symbolic value of the output.

Symbolic execution terminates when all instructions have been processed. At the point, we conjunct the generated constraints with a constraint that limits the symbolic output sequence out to the concrete output sequence recorded in the original run. The result is our formula. For example, the augmented formula for Schedule 3 from Table 4 would be 0≠13 [symbol] out[0]=a² [symbol] out=4, since 4 was the recorded output of the original run.

### 7.4 Formula Solving

SI-NVI computes an output-reproducing set of input-values, if it exists, by dispatching the formula generated in the previous phase to an SMT solver—a program that decides the satisfiability of logical formulas. Our SMT solver of choice is STP [2]. In this work, we treat STP largely as a blackbox that takes a logical formula and produces a satisfying assignment if it exists. For example, when given the formulas for Schedules 1 and 2 from Table 4, STP correctly reports that they have no satisfying assignment, hence telling us to try another schedule or path. But when given the formula for Schedule 3 or 4, STP produces a satisfying assignment, thereby allowing us to terminate our search.

The generated formula needn't have a unique solution, and STP can be made to report all possible solutions. In Schedules 3 and 4, for example, the program will output 4 for inputs 2 and −2. Furthermore, there may be multiple program paths and/or schedules that generate satisfiable formulas. For example, Schedule 3 and Schedule 4 generate the same satisfiable formula. In such cases, output-determinism allows any such solution since they all result in the original output. In general, output-determinism doesn't imply input, path, or schedule determinism.

### 7.5 Tradeoffs

The benefit of SI-NVI is its low record-mode overhead—it requires ODR to log just the execution outputs. But this gain in efficiency comes with a price—a severe loss of search scalability. That is, SI-NVI doesn't scale beyond the simplest of programs, since it searches the space of all program paths, inputs, and interleavings—each of which is exponential in size. In Section 8, we present a variant of NVI that does scale.

### 8 RECORD-INTENSIVE NVI

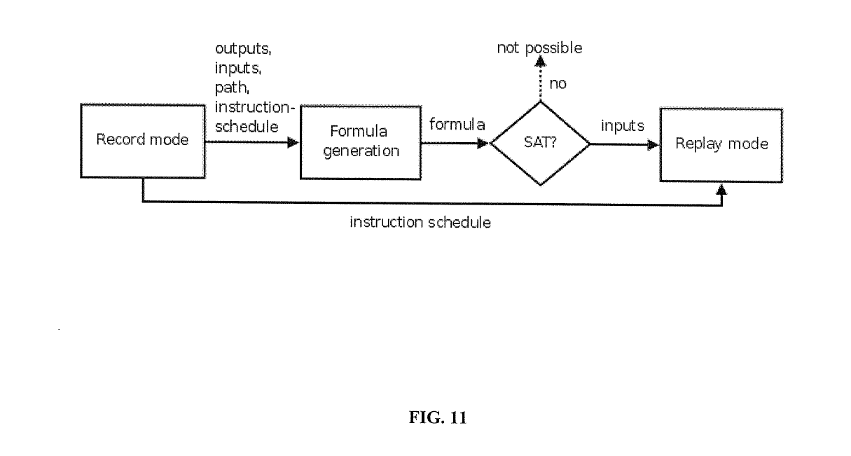

Depicted in FIG. 11, Record-Intensive NVI (RI-NVI) employs the same three-step search algorithm as Search-Intensive NVI. But unlike Search-Intensive NVI, RI-NVI leverages additional properties of the original run to reduce the search space of paths, inputs, and schedules by exponential quantities. We present these search-space reductions below.

### 8.1 Input Reduction

To reduce the search-space of inputs, Scalable NVI employs input-guidance—the idea that we can find an output-deterministic execution by focusing the search on input values acquired in the original run. Scalable NVI applies input-guidance during formula generation by constraining the symbolic targets of all program inputs to the input values obtained in the original run. For instance, in Table 1, symbolic variable a, which was unconstrained in Basic NVI, would be constrained to −2—the input value provided during the original run.

As shown in FIG. 11, input-guidance requires ODR to record the original run's inputs, much like a traditional replay system. Inputs come mainly from devices, such as the network, disk, or peripherals. ODR records such inputs largely by intercepting and logging the return values and data-buffers of the sys_read( ) and sys_recv( ) family of system calls. We model exceptional events (such as interrupts) as control-flow changes rather than as inputs.

### 8.2 Path Reduction

To reduce the search-space of program paths, Scalable NVI leverages path-guidance. The key observation behind path-guidance is simple: we need only consider executions that follow the original run's path to find one that produces the same output. For example, if we know that the branch in our running example was not taken in the original run, then there is no sense in exploring the taken branch—and in this case, the taken branch will not produce the same output.

Thus, by restricting constraint generation and solving to only the original run's path, path-guidance effects an exponential reduction in search time.

To use path-guidance, Scalable ODR must record the program path. A naive way to capture the path is to trace the instruction counter values for each thread. A more efficient method, employed by ODR, is to record the outcomes of all conditional branches, indirect jump targets, and exceptional control-flow changes (e.g., signals) for all threads. Conditional branch outcomes are recorded as a bit-string (e.g., with 1 for taken and 0 for not-taken) while indirect jump targets are recorded verbatim. Exceptional control-flow events are captured by their instruction-count (or for x86, the <eip, ecx, branch count> triple) at the exception-point.

### 8.3 Schedule Reduction

Scalable NVI uses i(instruction)-schedule guidance to reduce the search-space of instruction schedules. The idea is that we need only search along the original run's i-schedule to find an execution that produces the same output. For example, if Scalable NVI is told that our running example executed Schedule 3 (shown in Table 1), then we needn't have searched along Schedules 1 or 2, which, in our example program, will not produce an output-deterministic execution. The result would be another exponential reduction in search time.

To effect i-schedule guidance, we must record the original run's i-schedule. ODR captures the schedule using a Lamport clock, a monotonic counter that is incremented and recorded after each instruction. In the case of i-schedules, the Lamport clock assignments describe a total-ordering of all instructions. To reproduce the total-ordering, then, we simply interleave instructions in increasing Lamport clock order.

### 8.4 Tradeoffs

Input, path, and instruction-schedule guidance enable Scalable NVI to find an output-deterministic execution in just one iteration. But this search efficiency comes at the expense of considerable record-mode performance. In particular, i-schedule guidance calls for recording the total-ordering of instruction interleavings. And as discussed in Section 3, obtaining such a total-ordering means serializing instruction-execution of the original run. Below, we present a new variant of NVI that avoids logging the i-schedule and hence achieves lower record-overheads.

### 9 VALUE-INCONSISTENT NVI

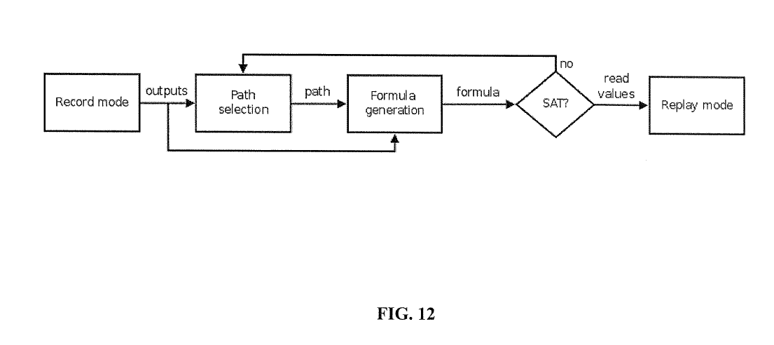

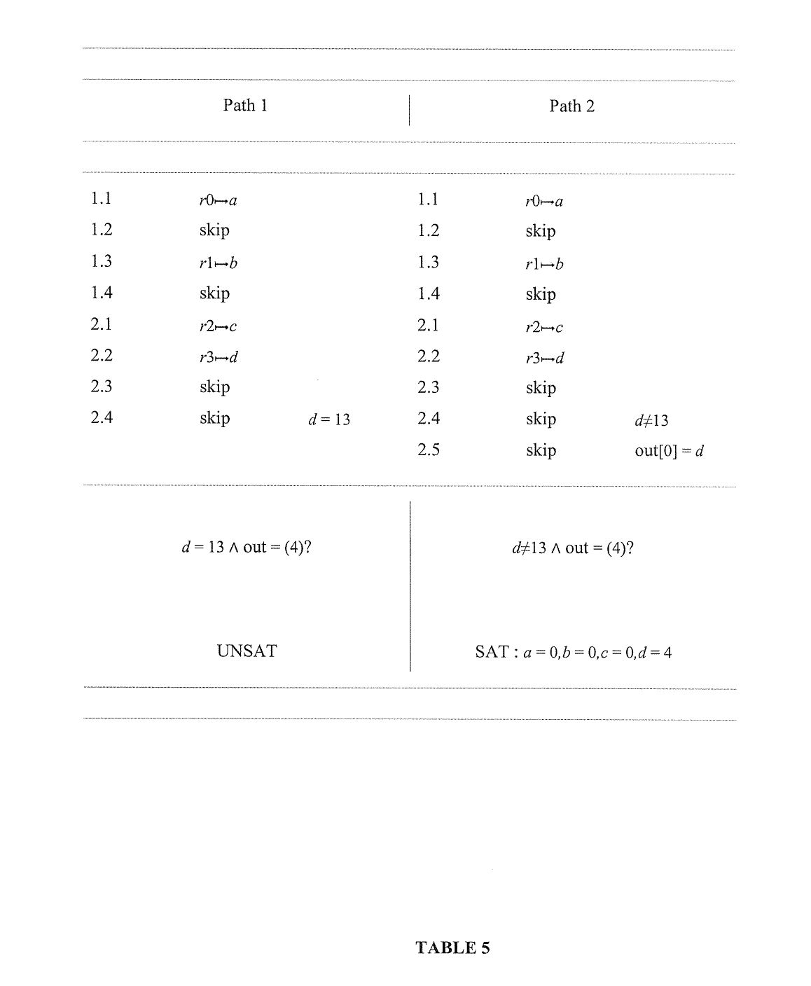

Value-Inconsistent NVI (VI-NVI), shown in FIG. 12, requires only that the original run's output be recorded. Given the output, it directly infers a set of memory-read values that, when substituted in future program runs, guarantees output-determinism on every replay execution. VI-NVI uses a three-step search algorithm similar to that of Search-Intensive NVI. But unlike SI-NVI, VI-NVI sacrifices the quality of the computed execution to exponentially reduce the search space of schedules.

VI-NVI uses consistency-relaxation to reduce the search-space of schedules. The observation behind consistency-relaxation is that the access-values of the computed execution needn't conform to the host machine's memory-consistency model for it to produce the same output. In fact, computed access-values needn't be consistent at all. For example, for path P₂, an assignment of {r0=0, r1=1, r2=4,r3=0} is sufficient for 4 to be printed, despite the fact that the assignment is inconsistent with the host's memory model: r0 should be −2 or 2 if the output is to be 4.

Consistency-relaxation, taken to its extreme, enables VI-NVI to forego the search for a host-consistent execution. In particular, VI-NVI computes an execution in which access-values are null-consistent—as though the execution took place on a machine that returns arbitrary values for memory-reads. The benefit of null-consistency is that it doesn't require searching all i-schedules. In fact, VI-NVI needs to explore only one, arbitrary-selected i-schedule for each selected path, because null-consistency dictates that instruction ordering has no effect on the values read from memory.

### 9.1 Computing Access-Values

To derive a null-consistent execution, we must compute read-access values that, although inconsistent with other memory-accesses, make the program produce the same output. VI-NVI computes these values using the same formula generation procedure as SI-NVI, but with a tweak. In particular, VI-NVI assigns a new symbolic variable to the targets of each memory-read, hence allowing the computed value of that read to be any value consistent with the output. This contrasts with SI-NVI where symbolic variables are assigned only to program inputs and where reads must be consistent with the host's memory model as well as the output.

Table 5 shows VI-NVI's formula generation in action.

### 9.2 Tradeoffs

Despite its low record-mode overhead and reduced (though still exponential) search complexity, VI-NVI is inadequate for debugging purposes. Namely, null-consistency prevents reasoning about causality chains spanning memory operations.

### 10 COMPOSITE-PRIME NVI

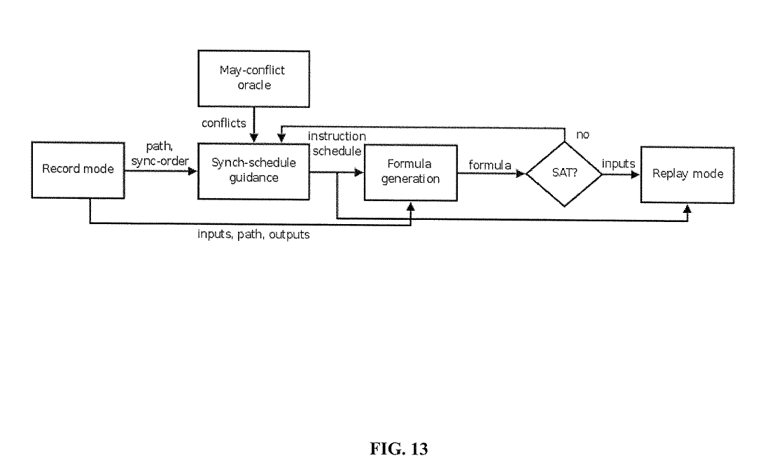

Composite-Prime NVI (CP-NVI) is an inference method that combines the qualities of Search-Intensive and Record-Intensive NVI to yield practical record-overheads and search times. Depicted in FIG. 13, CP-NVI uses input and path guidance to reduce the search-space of inputs and paths—just like RI-NVI. But unlike RI-NVI and more like SI-NVI, CP-NVI searches the space of schedules, albeit a limited region, to avoid the cost of recording instruction-ordering. Unique to CP-NVI, we term this search method synchronization-schedule guidance. To ease exposition, the following sections develop synchronization-schedule guidance through a series of successively-refined schedule reductions.

### 10.1 Definitions

Definition 3. We say that two memory accesses in an execution conflict if they both reference the same location and at least one of them is a write.

Definition 4. We say that two access instructions in path P may-conflict (or are potentially-conflicting) if they conflict in some execution along path P. For example, in path P₂=(T₁, T₂) from Table 1, access-instructions 1.4 and 2.2 (short for T₁(4) and T₂(2)) may-conflict.

Definition 5.

A conflict-schedule (P, [symbol] c) is a partial order over the instructions in path P such that, for all x,y [symbol] P, x [symbol] c y if x and y may-conflict, are from different threads, and x is scheduled before y. For example, {(1.2, 2.1), (1.4, 2.2), (2.2, 2.3)} and {(1.4, 2.2), (1.2, 2.1), (2.2, 2.3)} are two different conflict-schedules for P₂=(T₁, T₂),

Definition 6. A synch(ronization)-schedule (P, [symbol] ) is a partial order over the instructions in path P such that, for all x,y [symbol] P, x [symbol] s y if x and y are synchronization instructions and x is scheduled before y. For example, {(1.4, 2.2)} and {(2.2, 1.4)} are two different synch-schedules for P₂=(T₁, T₂),

Definition 7. Let the immediately precedes relation (P, [symbol] ) between instructions of a thread-sequence Tᵢ in P be as follows: ∀i, e [symbol] if e immediately precedes f in Tᵢ. Then a linearization Linear(o) of some partial order o on P is an i-schedule consistent with the transitive closure of o U(P, [symbol] )

### 10.2 Conflict-Schedule Search

The first reduction in the series, which we term conflict-schedule search, is based on the observation that one needn't search all i-schedules; it suffices to search only the set of conflict-schedules. Theorem 1 formalizes and justifies this observation.

THEOREM 1. Let c=(P, [symbol] ) be a conflict-schedule of some path P and let Formula (i) be the set of constraints generated using symbolic execution on some i-schedule i. Then, ∀x,y [symbol] Linear(c): Formula(x)=Formula (y).

PROOF. See appendix.

[symbol]

To search the space of conflict schedules, we need to know which accesses may conflict. We delegate the task of may-conflict detection to a may-conflict oracle, depicted in FIG. 7. We defer detailed treatment of the oracle to section REF, but for now assume that, given a path P, the oracle identifies a sound and precise set of instructions that may-conflict in some execution along path P. For example, given path P₂=(T₁,T₂), the may-conflict oracle will return the path instruction-set {1.2, 1.4, 2.1, 2.2, 2.3}.

### 10.3 Conflict-Schedule Guidance

A real program run may have billions of conflicting accesses, so searching all conflict-schedules is prohibitive. The second reduction in the series, which we term conflict-schedule guidance, is based on the observation that, to find an output-deterministic run, it suffices to search some i-schedule consistent with the original run's conflict-schedule. Theorem 2 formalizes and justifies why this is so.

THEOREM 2. Let i be the original run s i-schedule and c be the original run s conflict-schedule. Then ∀x [symbol] Linear(c): Formula (i)=Formula(x).

PROOF. Since i [symbol] Linear(c), it follows from Theorem 1 that symbolic-execution of i and l result in identical formulas.

[symbol]

Conflict-guidance calls for recording the original run's conflict-schedule. One approach is to first identify potentially-conflicting access instructions using the conflict-oracle, and then record their ordering using Lamport clocks.

### 10.4 Synchronization-Schedule Guidance

The final schedule-reduction in the series, and the one used by CP-NVI, is synch(ronization)-schedule guidance. It leverages the fact that it suffices to search only those conflict-schedules consistent with the original run's synch-schedule. Theorem 3 formalizes and justifies this observation.

THEOREM 3. Let s=(P, [symbol] ) be the original run s synch-schedule and s⁺ denote the transitive-closure of the union of s and (P, [symbol] ). Let Conflict(s)={(x,y) [symbol] s⁺|MayConflict(x,y)} be the set of all conflict-orderings captured by the synch-schedule. And let Consched(s)={a|a=(P, [symbol] ) [symbol] Conflict(s)⊂a} be the set of all conflict-schedules consistent with the synch-schedule. Then ∃a [symbol] Consched(s),∀x [symbol] Linear(a): Formula(x)=Formula (i).

PROOF. Let c be the original run s conflict-schedule. If (x,y) [symbol] Conflict(s), then by the definition of conflict-schedule, (x,y) [symbol] c. Hence Conflict(s) ⊂c, and therefore c [symbol] Consched(s). The rest follows from Theorem 2. □

To leverage synch-schedule guidance, ODR records the synch-schedule during the original run. ODR encodes the synch-schedule using a Lamport clock that is incremented and recorded at each synchronization instruction. Then to generate an i-schedule consistent with the recorded synch-schedule, we need only schedule instructions in increasing clock order.

Synchronization operations, for the most part, are easily identified and instrumented by opcode inspection. The exception is Dekker-style synchronization, which doesn't rely on hardware synchronization primitives and therefore is opcode-indistinguishable from ordinary reads and writes. We treat such synchronization and the conflicting-accesses it protects as races, with the penalty being an increase in |Consched(s)|. Fortunately, this type of synchronization is rare in x86 programs—we haven't encountered it in our experiments.

### 10.5 Tradeoffs

The effectiveness of synch-schedule guidance depends on |Consched(s)|, and that in turn depends on the number of unsynchronized conflicts (i.e., races) there are in P. Theorem 4 shows that, for the case where P is data-race free, |Consched(s)|=1, and so CP-NVI converges in one iteration.

THEOREM 4. Let s and i be the synch-schedule and i-schedule, respectively, of the original run's data-race free path P. Then ∀x [symbol] Linear(s): Formula(x)=Formula (i).

PROOF. Let s⁺ be the transitive closure of the union of s and (P, [symbol] ), and c⁺ be the transitive closure of the union of c and (P, [symbol] ), where c is the original run s conflict-schedule. Since P is data-race free, then c⁺⊂s⁺. Then, by the definition of Linear, Linear(s)⊂Linear(c) and hence x [symbol] Linear(c). Since i [symbol] Lineage), the rest follows from Theorem 1. □

Of course, real programs have data-races, and CP-NVI still works in their presence. But it may need to explore all conflict-schedules in Consched(s), where |Consched(s)| is exponential in the number of data-races, before converging. Our results in Section 13 suggest that, in practice, the number of data-races (including benign races) in realistic runs is high and hence the number of conflict-schedules that must be explored is high as well. We remedy this problem in our final infernce method, described in Section 11.

### 11 COMPOSITE NVI

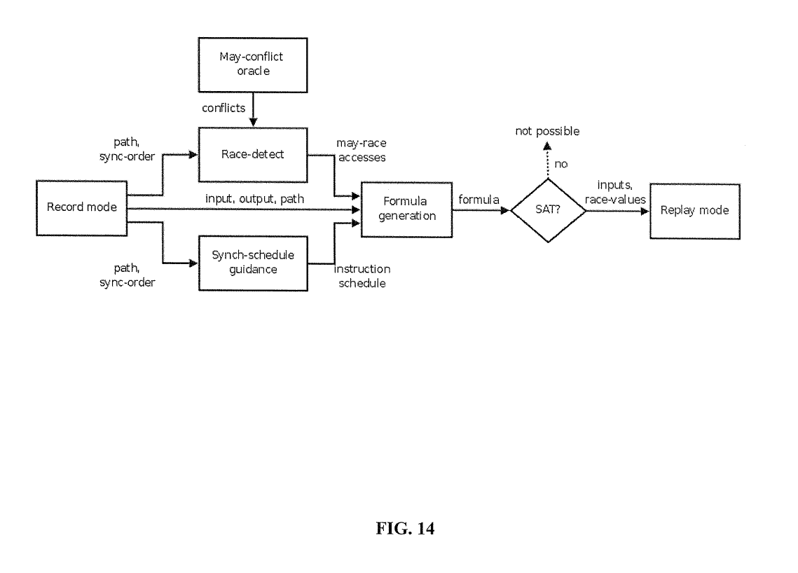

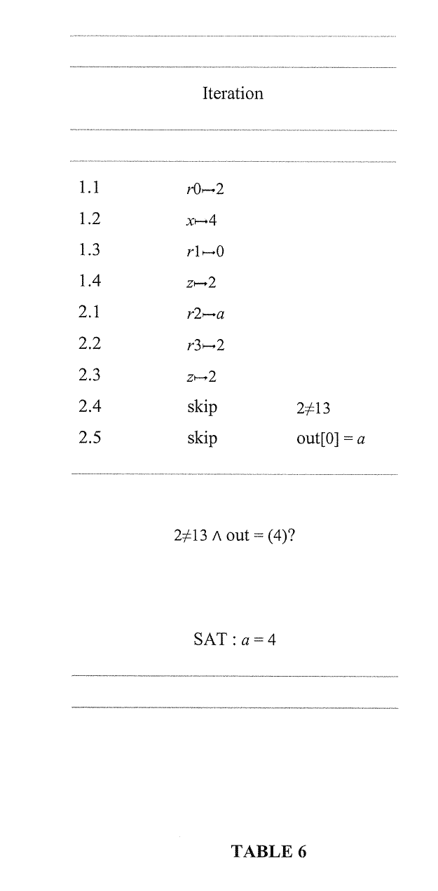

We merge Composite-Prime NVI and Value-Inconsistent NVI to form Composite NVI (COMP-NVI), the inference method used in ODR. COMP-NVI, depicted in FIG. 14, uses input, path, and synch-schedule guidance to provide low record overhead, much like CP-NVI. And like VI-NVI, COMP-NVI sacrifices the consistency of inferred access values, though in a limited fashion, to provide one-iteration search convergence.

The heart of COMP-NVI is a schedule reduction we term race-consistency relaxation. The observation behind race-consistency relaxation is that race-values needn't be host-consistent for the program to produce the same output. In fact, they may be completely inconsistent. This observation enables COMP-NVI to relax the race-value consistency of the computed execution and still obtain output-determinism.

The key benefit of race-consistency relaxation is that it allows COMP-NVI to avoid exploring all of Linear(s), the set of linearizations of the recorded synch-schedules s. In fact, race-consistency relaxation requires that COMP-NVI explore only one such linearization, since for any element of Linear(s), there must exist an assignment of race-values such that the program produces the same output (e.g., the race-values of the original run). Race-consistency relaxation enables COMP-NVI to terminate in one search-iteration.

### 11.1 Computing Race-Values

To compute output-reproducing race-access values, COMP-NVI uses the same formula generation method as SI-NVI, but with a tweak: it assigns a new symbolic variable to the target of each racing-read, hence allowing the computed value of that read to be any value consistent with the output. This contrasts with VI-NVI, where symbolic variables are assigned to all read targets, and where even non-racing reads may be inconsistent.

Table 6 shows COMP-NVI's formula generation in action.

### 11.2 Race Detection

Given the path, synchronization schedule, and query-access to a may-conflict oracle, our race detector reports the may-race set—the set of all potentially-racing access instructions along the recorded path.

To compute the may-race set, our detector employs a static, path-directed, happens-before race-detection scheme that, in its simplest form, works in three steps.
1. Identify concurrent accesses. Let s⁺ denote the transitive closure of s∪(P, [symbol] ), where s is the recorded synch-schedule and (P, [symbol] [symbol] ), is the recorded thread-local schedule (as described in Section REF) of path P. Then we say that accesses a are concurrent, denoted a∥b, if (a,b)/ [symbol] s⁺ and (b,a)/ [symbol] s⁺. s⁺ can be generated by a union-find algorithm.
2. Identify potentially-conflicting accesses. To determine if a pair may be in conflict, the detector queries the may-conflict oracle. The precise operation of the oracle is deferred to section REF.
3. Report access-pairs that are concurrent and potentially-conflicting. Specifically, report the set {(a,b): a,b [symbol] P [symbol] (a∥b) [symbol] (b [symbol] MAY-CONFLICT(a))}.

As described, our race-detector requires considerable recourses to compute s⁺. After all, real program paths have billions of accesses, and computing their transitive-closure will require considerable storage (disk and memory). The end result is that the detector will be very slow. To be practical, ODR uses a variant of the above detector that, at any given times, stores ordering information of only a small-subset of accesses. We borrow this method largely from RecPlay, to which we refer the interested reader for further details.

### 11.3 Tradeoffs

COMP-NVI's low record-overhead and search-time come at the expense of race-value inconsistency. Though the degree of inconsistency is much lower than in runs generated by VI-NVI, it may be sufficient to disrupt the causality chain of a failure and hence confuse the developer.

In practice, we haven't found the inconsistency to be detrimental to debugging. The main reason is that, as shown in Section REF, most generated runs are value-deterministic, and hence all accesses, including computed race-values, conform to a run on the host-machine. Thus, the degree of inconsistency in practice is low.

### 12 IMPLEMENTATION

ODR consists of approximately 100,000 lines of C code and 2,000 lines of x86 assembly. The replay core accounts for 45% of the code base and took three man-years to develop into a working artifact. The other code comes from Catchconv and LibVEX, an open-source symbolic execution tool and binary translator, respectively.

### 12.1 Challenges

We encountered many challenges when developing ODR. Here we describe a selection of those challenges most relevant to our inference method.

### 12.1.1 Capturing Inputs and Outputs

To capture inputs and output, we employ a kernel module—it generates a signal on every system call and non-deterministic x86 instruction (e.g., RDTSC, IN, etc.) that ODR then catches and handles. DMA is an important I/O source, but we ignore it in the current implementation. Achieving completeness is the main challenge in user-level I/O interception. The user-kernel interface is large—at least 200 system calls must be logged and replayed before sophisticated applications like the Java Virtual Machine will replay. Some system calls such as sys_gettimeofday( ) are easy to handle—ODR just records their return values. But many others such as sys_kill( ) sys_clone( ) sys_futex( ) and sys_open( ) require more extensive emulation work—largely to ensure deterministic signal delivery, task creation and synchronization, task/file ids, and file/socket access, respectively.

### 12.1.2 Tracing Branches and Synchronization

Our inference procedure relies on the original execution's branch trace. We capture branches in software using the Pin binary instrumentation tool. Software binary translation incurs some overhead, but it's a lot faster than the alternatives (e.g., LibVEX or x86 hardware branch tracing). To obtain low logging overhead, we employ an idealized, software-only 2-level/BTB branch predictor to compress the branch trace on the fly. Since this idealized predictor is deterministic given the same branch history, compression is achieved by logging only the branch mispredictions. The number of mispredictions for this class of well-studied predictors is known to be low.

Our inference procedure also needs to know the original execution's synchronization ordering. We use Pin to intercept synchronization at the instruction level. Specifically, we associate a logical clock with the system bus lock. We record the clock value every time a thread acquires the bus lock and we increment the clock value on release. We could've intercepted synchronization at the library level (e.g., by instrumenting pthread_mutex_lock( ), but then we would miss inlined and custom synchronization routines which are common in libc.

### 12.1.3 Generating Constraints

There are many symbolic execution tools to choose from, but we needed one that worked at user-level and supports arbitrary Linux/x86 programs. We chose Catchconv—a user-mode, instruction-level symbolic execution tool. Though designed for test-case generation, Catchconv's constraint generation core makes few assumptions about the target program and largely suits our purposes.

Rather than generate constraints directly from x86, Catchconv employs LibVEX to first translate x86 instructions into a RISC-like intermediate language, and then generates constraints from this intermediate language. This intermediate language abstracts-away the complexities of the x86 instruction set and thus eases complete and correct constraint generation. Catchconv also implements several optimizations to reduce formula size.

### 13 PERFORMANCE

In this section, we study ODR's performance with Hybrid NVI. Our study focuses on three applications: the Apache web-server, Sun's Hotspot JVM running the Apache Tomcat web-server, and Radix—a radix-sorting program from the SPLASH2 suite. We chose Apache and Java-Tomcat because we wanted to see how ODR would fare on large server applications with potentially many races. We chose Radix because its CPU-intensive nature makes it the worst-case scenario for ODR's path-tracing.

We configured Apache to use 8 worker processes, but left Tomcat at its default threaded worker configuration. To generate workloads for these servers, we used an off-site web-crawler to fetch all website pages as fast as possible. We configured Radix to run using 2 threads and selected parameters so that native runtime was about 60 seconds.

We conducted our performance experiments on a dual-core Pentium D machine running at 2.0 GHz with 2 GB of RAM. We enabled all ODR optimizations described in Section??. Our experimental procedure consisted of a warm-up run followed by 6 trials. We report the averages of these trials.

### 13.1 Record Mode

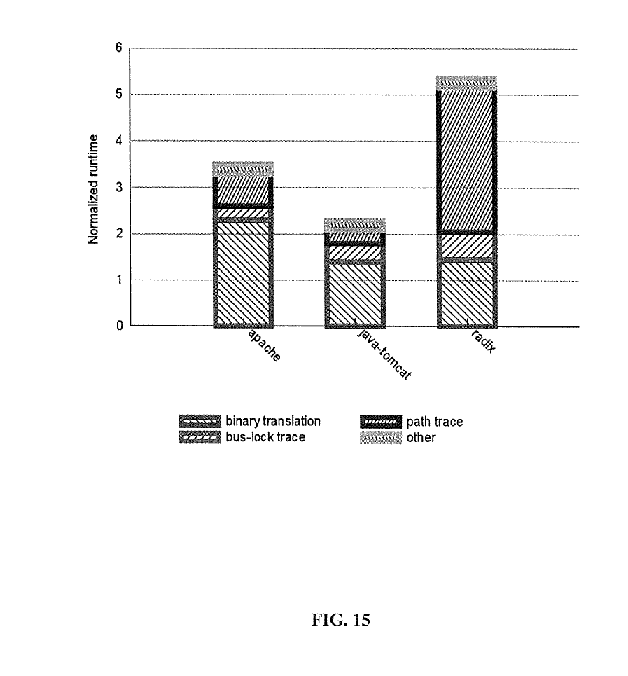

FIG. 15 shows the slowdown factors for recording, normalized with native execution times. ODR has an average overhead of 3.8×, which is a factor of 8 less than the average overhead of iDNA [1]—a software-only replay system that logs memory accesses. This is because our most expensive operation, obtaining a branch trace, is not nearly as expensive as intercepting and logging memory accesses.

On the other hand, ODR's overheads are currently greater than other software-only approaches, for some applications. Radix, for example, takes 3 times longer to record on ODR than with SMP-ReVirt [3], a replay system that serializes conflicting shared-memory accesses. This slowdown is due largely to path-tracing and binary translation costs, neither of which is used in SMP-ReVirt. Radix, a CPU-bound application, suffers the most from path-tracing because our on-the-fly compression method inflates each sorting iteration by several dozen instructions.

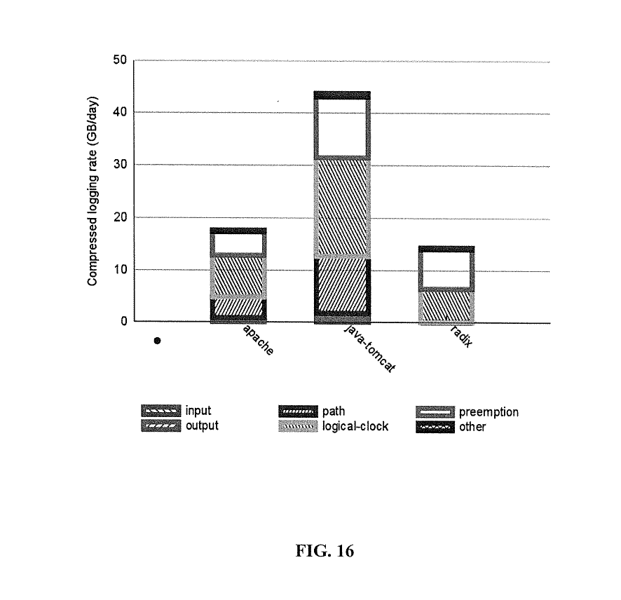

FIG. 16 shows logging rates for two-processor execution and decomposition by major log entries. The rates given are the sum of the logging rates for each CPU.

ODR's logging rate for Radix, though less than half that of SMP-ReVirt, is much higher than other user-level replay systems. Path-tracing costs, though significant, don't completely account for this disparity. What's more, ODR's logging rate for the web-servers is about as high as that of SMP-ReVirt. This is surprising since we don't record whole-system execution.

As shown in FIG. 16, we can trace the high rates to two implementation inefficiencies. The first results from recording an entire 32-bit logical clock value every time a thread acquires the bus-lock, even when logging just the increments suffices. The second results from ODR preempting threads even when there is no contention for the CPU. Radix, for example, takes preemptions even though there is only 1 thread on each CPU.

13.2 Inference mode

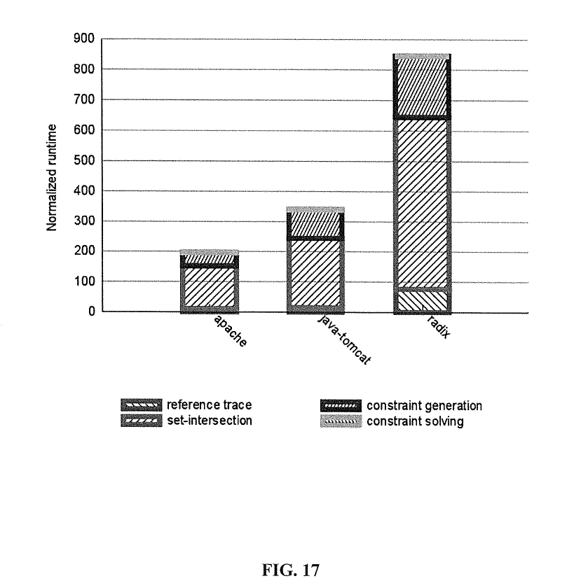

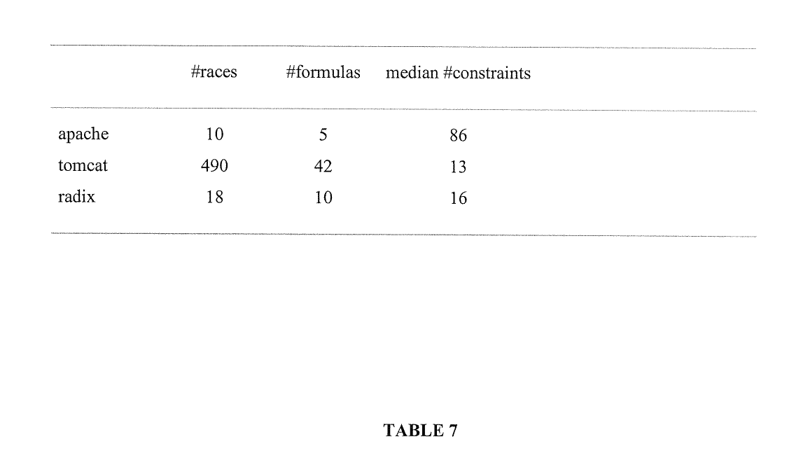

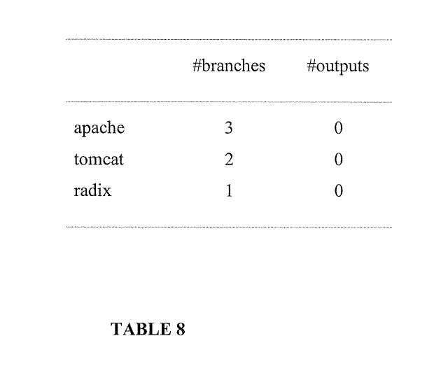

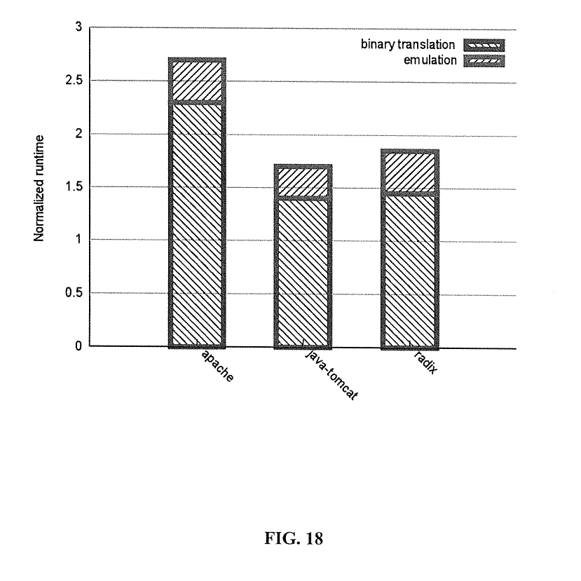

FIG. 17 shows the normalized runtime for NVI. The runtime is the sum of the runtimes for each of the three inference phases: race-detection, formula generation, and formula solving. We've split the race-detection time into its two sub-phases: reference trace collection and set-intersection (see Section herein for details about these phases).

As expected, inference is very costly, taking as long as 15 hours to complete in the case of Radix. But surprisingly, much of the cost comes from race-detection rather than constraint solving—an NP-complete procedure. We attribute this largely to the optimizations described herein—they reduce formula size considerably.

Radix's race-detection suffers the most because of its high memory access rate. As FIG. 17 shows, much of the race-detection cost stems from set-intersection. This makes sense—our naive O(n²) set intersection algorithm drops to a crawl when dealing with millions of memory references.

Though the cost of race-detection is high, there is an upside: extremely small formula solving time. To determine why solving time is so short, we counted the number of formulas generated for each replay execution, as well as the number of constraints per formula. We give the results in Table 7 alongside the number of races found in each program execution.

These results show three reasons for the small formula solving time. First, each execution has a small number of races—thanks in no small part to the precision of happens-before race-detection. The second reason is that the number of generated formulas is far fewer than the number of races in the execution. Only 8% of the races found in Java-Tomcat generate formulas, for instance. And third, if a formula is generated for a race, then it is likely to be very small.

To see why some races didn't result in formulas. we measured the impact of each race on the host program's path and output. The results, shown in Table 5, show that 40% of all races affect neither branches nor outputs (see 14.2 for an example). If a race doesn't affect branches or outputs, then NVI will not generate constraints for that race. Table 8 also tells us why those races with formulas are so small: races tend to influence only a hand-full of branches.

### 13.3 Replay Mode

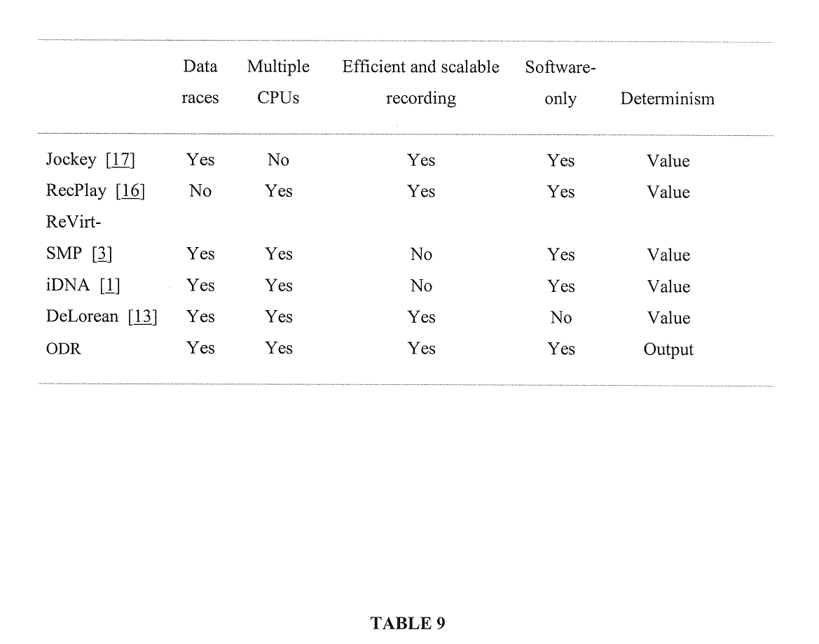

FIG. 18 shows the replay times for a two-processor recording session. The key result here is that replay proceeds at near native speeds, despite the fact that inference time can be very long. This makes sense—once non-deterministic values are computed, they can simply be plugged-in into future re-executions.

There is some overhead because of binary translation (done with Pin), which we need in order to intercept bus-lock instructions and replay synchronization ordering. Additional overhead includes that of intercepting syscalls to replay inputs and detecting the instructions at which inferred race-values should be substituted. Both are rolled into the emulation category.

### 14 CASE STUDIES

The most surprising result of this work is that formula solving time is not the bottleneck in computing a output-deterministic execution. As shown above, solving time is small because NVI generates small formulas. To understand why the formulas are small, we analyzed the formulas that NVI generated for several races we found in real software. Here we present inference results for two of those races.

The races we present both come from a run of the Java VM. But neither came from the JVM code itself. Rather, they came from libc (the C library) and ld (the dynamic linker). Hence all software linked with these libraries is susceptible to the races described here.

For each example, we provide context, point out how the races comes about, and analyze the NVI-generated constraints and their solutions. The constraints given here are a distilled version of the actual constraints given to STP.

### 14.1 C Library

libc's_IO_fwrite function uses a recursive lock to prevent concurrent accesses to internal file buffers. The recursive lock permits deadlock-free lock acquisition by the thread that already owns the lock. Before acquiring a lock, the recursive lock first checks ownership by reading the lock structure's ownership field, and if the current owner is itself (due to recursive locking), skips busy-waiting on the lock to become unlocked, hence avoiding deadlock.

In the scenario below, thread 1 performs the check for recursive acquisition (instruction block at 0xa63c2a) while another tries to acquire the lock (instruction 0xa63c49) through the use of CMPXCHG (instruction block at 0xa63c49). The CMPXCHG instruction compares the values in the EAX register with destination operand (ESI), and if the two values are equal, writes the source operand (ECX) into the destination. Here CMPXCHG is used to atomically check that the lock variable is 0 (indicating that it is unlocked) and if so, sets it to a non-zero value to lock it.

Thread 1 (reader)
00a63bf0 <_IO_fwrite>:
...
a63c2a: mov %gs:0x8,%eax
a63c30: mov %eax,0xfffffff0(%ebp)
a63c33: cmp %eax,0x8(%edx)
a63c36: je a63c5c <_IO_fwrite+0x6c>
...
Thread 2 (writer)
00a63bf0 <_IO_fwrite>:
...
a63c49: lock cmpxchg %ecx,(%edx)
a63c4d: jne a63d4f <_L_lock_51>
a63c53: mov 0x48(%esi),%edx
a63c56: mov 0xfffffff0(%ebp),%eax
a63c59: mov %eax,0x8(%edx)
...

Race: Although thread 2's write (via CMPXCHG) to the lock variable holds the bus lock, thread 1's read (i.e., check for recursive acquisition) does not. Hence conflicting accesses to the lock variable are not serialized.

This is a benign race. To see this observe that thread 2's lock acquisition attempt will fail if thread 1 already owns the lock. And if thread 1 doesn't own the lock, then both thread 1 and 2 will compete for the lock. Hence the critical section remains protected in all cases.

Constraints generated: As before, the generated constraint depends largely on the recorded branch and output trace. After one recording, NVI with all optimizations and refinements generated the following formula. owner is the symbolic variable for thread l's racing read.

```
ASSERT(eflags.ZF =
  (owner ==SELF_TID ? 1 : 0));
ASSERT(eflags.ZF == 0).
/* Coherence refinement -- 3874 is
  thread 2's tid. */
ASSERT(owner == SELF_TID || owner == 3874);
```

The first constraint results from CMP's read of the lock variable. Unlike the MOV class of instruction that modifies general-purpose registers, CMP affects the ZF bit in the EFLAGS register (among others). The second constraint results from the jump—the recorded execution showed that the JE was not taken (which implies that ZF was not set) and hence thread 1 did not own the lock. The final constraint, due to coherence refinement, accounts for thread 2's concurrent lock-acquisition.

Race-value inferred: STP provides the assignment owner=3874, which incidentally, is the same value loaded for the read of owner in the original execution. Thus, in this case, NVI provides value-determinism in addition to output-determinism.

### 14.2 Dynamic Linker

Before a thread can access a global variable or function in another shared library, the Linux dynamic linker ld.so must perform a symbol lookup to determine the absolute address of the variable or function. In doing so, the linker maintains a statistics counter of the number of lookups it has performed thus far.

The counter is updated using the ADD instruction, which reads from a target memory location, increments the read value, and updates the target location. In this case, thread 1 increments the target memory location concurrently with thread 2.

Thread 1 (reader, writer)
009f98d0 <_dl_lookup_symbol_x>:
...
9f9938: addl $0x1,0x2b0(%ebx)
...
Thread 2 (reader, writer)
009f98d0 <_dl_lookup_symbol_x>:
...
9f9938: addl $0x1,0x2b0(%ebx)
...

Race 1: Thread 1's pre-increment read of the counter races with thread 2's post-increment write, and thread 2's pre-increment read races with thread 1's post-increment write. This is clearly a bug—the increment should be protected by a lock.

Race 2: Thread 1's post-increment write races with thread 2's post-increment write. Again a bug.

Constraints generated: No constraints were generated for either of these races. The reason is that no branches or output syscalls acted on the value in the lookup counter. Justifiably so, because the lookup statistics were not printed out in any of our original executions. This is a prime example of a frequent race that has no effect on constraint size.

### Limitations

ODR has several limitations that warrant further research. We provide a sampling of these limitations here.

Unsupported constraints. For inference to work, the constraint solver must be able to find a satisfiable solution for every generated formula. In reality, constraint solvers have hard and soft limits on the kinds of constraints they can solve. For example, no solver can invert hash functions in a feasible amount of time, and STP can't handle floating-point arithmetic.

Fortunately, all of the constraints we've seen have been limited to feasible integer operations. Nevertheless, we are exploring ways to deal with the eventuality of unsupported constraints. One approach is to not generate any constraints for unsupported operations, and instead make the targets of those operations symbolic. This in effect treats unsupported instructions as blackbox functions that we can simply skip during replay.

Symbolic memory references. Our constraint generator assumes that races don't influence pointers or array indices. This assumption holds for the executions we've looked at, but may not for others. Catchconv and STP do support symbolic references, but the current implementation is inefficient—it models memory as a very large array and generates an array update constraint for each memory access, thereby producing massive formulas that take eons to solve. One possible optimization is to generate updates only when we detect that a reference is influenced by a race (e.g., using taint-flow).

Inference time. The inference phase is admittedly not for the impatient programmer. The main bottleneck, happens-before race-detection, can be improved in many ways. An algorithmic optimization would be to ignore accesses to non-shared pages. This can be detected using the MMU, but to start, we can ignore accesses to the stack, which account for a large number of accesses in most applications. An implementation optimization would be to enable LibVEX's optimizer; it is currently disabled to workaround a bug we inadvertently introduced into the library.

Recording overhead. ODR's current recording slowdown is much too high for always-on operation. It's unlikely that we'll be able to reduce the binary translation costs much further—Pin is among the fastest translators available and writing a custom translator may not be worth the effort. However, initial evidence does indicate that much more can be done to reduce path-tracing costs. In particular, we were able to get path-tracing overheads as low as 38% if we switched from the on-the-fly path compression scheme to a simpler path tracing scheme. The lack of compression will increase the memory requirement, but that may be managed efficiently using a circular buffer.

### 16 RELATED WORK

Table 9 compares ODR with other replay systems along key dimensions.

Many replay systems record race outcomes either by recording memory access content or ordering, but they either don't support multiprocessors or incur huge slowdowns. Systems such as RecPlay and more recently R2 can record efficiently on multiprocessors, but assume data-race freedom. ODR provides efficient recording and can reliably replay races, but it doesn't record race outcomes—it computes them.

Much recent work has focused on harnessing hardware assistance for efficient recording of races. Such systems record more efficiently that our current implementation. But the hardware they rely on can be unconventional and in any case has yet to materialize. ODR can be used today and its core techniques (output/path tracing, race-detection, and inference) can be ported to a variety of commodity architectures.

ODR is not the most record-efficient multiprocessor replay system, even among software-only systems: SMP-ReVirt outperforms ODR by a factor of 3 on CPU intensive benchmarks for the two-processor case. Nevertheless, of all software systems that replay races, ODR shows the most potential for efficient and scalable multiprocessor recording. In particular, ReVirt-SMP serializes conflicting accesses hence limiting concurrency; ODR does not.

The idea of relaxing determinism is as old as deterministic replay technology. Indeed, all existing systems are relaxed determinism generators with respect to the bug-replay problem, as pointed out in above. ODR merely goes one step further. Relaxed determinism was recently re-discovered in the Replicant system, but in the context of redundant execution systems. Their techniques are, however, inapplicable to the bug-replay problem because they assume access to execution replicas in order to tolerate divergences.

An ODR has been described herein, a software-only, replay system for multiprocessor applications. ODR achieves low-overhead recording of multiprocessor runs by relaxing its determinism requirements—it generates an execution that exhibits the same outputs as the original rather than an identical replica. This relaxation, combined with efficient search, enables ODR to circumvent the problem of reproducing data races. The result is reliable output-deterministic replay of real applications.

For purposes of illustration, programs and other executable program components are shown herein as discrete blocks, although it is understood that such programs and components may reside at various times in different storage components of computing device, and are executed by processor(s). Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Embodiments of the system and method described herein facilitate configuring content of web and computer applications to improve user access to relevant content. Although the components and modules illustrated herein are shown and described in a particular arrangement, the arrangement of components and modules may be altered to perform analysis and configure content in a different manner. In other embodiments, one or more additional components or modules may be added to the described systems, and one or more components or modules may be removed from the described systems. Alternate embodiments may combine two or more of the described components or modules into a single component or module. While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” “various embodiments” or “other embodiments” means that a particular feature, structure, or characteristic described in connection with the embodiments is included in at least some embodiments, but not necessarily all embodiments. References to “an embodiment,” “one embodiment,” or “some embodiments” are not necessarily all referring to the same embodiments. If the specification states a component, feature, structure, or characteristic “may,” “can,” “might,” or “could” be included, that particular component, feature, structure, or characteristic is not required to be included. If the specification or Claims refer to “a” or “an” element, that does not mean there is only one of the element. If the specification or Claims refer to an “additional” element, that does not preclude there being more than one of the additional element.

1. A method for Data Center Replay (DCR), comprising:
running a program;
capturing data from a non-deterministic date source;
substituting the captured data into subsequent re-executions of the program;
re-running the program with the captured data; and
analyzing the re-running of the program.

2. A method according to claim 1, wherein the non-deterministic data source is a keyboard.

3. A method according to claim 1, wherein the analyzing the rerunning of the program includes analyzing the operations of the program with tracing tools.

4. A method according to claim 1, wherein the analyzing the rerunning of the program includes analyzing the operations of the program with race detection.

5. A method according to claim 1, wherein the analyzing the rerunning of the program includes analyzing the operations of the program with memory leak detection.

6. A method according to claim 1, wherein the analyzing the rerunning of the program includes analyzing the operations of the program with global predicates.

7. A method according to claim 1, wherein the analyzing the rerunning of the program includes analyzing the operations of the program with casualty tracing.

8. A method for reproducing electronic program execution, comprising:
running a program;
collecting output data while the program is running;
performing an output deterministic execution;
searching a predetermined space of potential executions of the program; and
calculating inferences from the collected output data to find operational errors in the program.

9. A method according to claim 8, wherein collecting output data includes collecting output data clues indicative of the operation of the program being run.

10. A method according to claim 8, wherein searching a space of potential executions includes searching the collected output data using symbolic reasoning to infer values of non-deterministic access values.

11. A system for reproducing electronic program execution, comprising:
a run module configured to run a program;
a collection module configured to collect data clues during the running of the program; and
an execution program configured to run the program in an output deterministic execution to determine operational errors in the program based on the data clues collected when the program is run in the run module.

12. A system according to claim 11, wherein collection module is configured to collect output data clues indicative of the operation of the program being run.

13. A system according to claim 11, wherein the execution module is configured to search a space of potential executions includes searching the collected output data using symbolic reasoning to infer values of non-deterministic access values.

14. A method for Data Center Replay (DCR), comprising:
running a collection of programs;
observing the behaviors of the programs while they are running; and
analyzing programs' executions that exhibit the observed behaviors

15. A method according to claim 14, wherein running a collection of programs includes:
running individual programs on distributed CPUs;
wherein distributed CPUs may be on the same machine or spread across multiple machines
wherein programs may communicate through shared memory if on the same machine or the network if on different machines

16. A method according to claim 14, wherein observing program behaviors includes:
collecting the values of program reads and writes from/to select inter-cpu communication channels;
wherein inter-cpu channels includes shared memory, console, network (e.g., sockets), inter-process (e.g., pipes), and file channels
wherein select inter-cpu channels include those that operate at low data rates, or those designated by the user as having low data rates
wherein collecting includes recording the data values to reliable storage

17. A method according to claim 14, wherein analyzing execution(s) consistent with the observed behaviors comprises of:
formulating queries for execution state of interest;
wherein formulating queries includes translating debugger state inspection commands to queries
wherein query specifies portion of program execution state to observe
wherein query includes those queries automatically generated by analysis tools as well as those generated by a person
providing values for execution state specified in the query; and
wherein values are provided by reconstructing execution state consistent with the observed behaviors
wherein reconstructing state values comprises of searching a predetermined space of potential programs' executions for one that exhibits the observed behavior; and
wherein searching includes using symbolic reasoning to infer program state of target execution
wherein the symbolic reasoning includes reasoning done on demand in response to queries
wherein the on demand reasoning includes doing only the work necessary to answer queries
wherein the symbolic reasoning includes reasoning done with the aid of an automated symbolic reasoning program (e.g., constraint solver or theorem prover)
wherein the predetermined space of potential executions includes only those executions that exhibit the observed behaviors
extracting specified state values.
inspecting returned execution state;
wherein inspecting includes checking return state for program invariant violations, data races, memory leaks, or causality anomalies.

18. A method for reproducing electronic multi-program execution, comprising:
running a collection of programs;
observing behaviors of the programs while they are running;
reconstructing programs' executions that exhibit the original executions' outputs; and
analyzing the reconstructed executions.

19. A method according to claim 18, wherein running a collection of programs includes:
running individual programs on different CPUs on the same machine

20. A method according to claim 18, wherein observing outputs and other program behaviors comprises of:
collecting the values of program outputs (i.e., writes to user-visible channels); and
wherein user-visible channels includes the console, network (e.g., sockets), inter-process (e.g., pipes), and file channels
optionally includes collecting the values of program reads from inter-cpu channels
wherein inter-cpu channels include shared-memory, keyboard, network, pipe, file, and device channels

21. A method according to claim 18, wherein reconstructing program executions comprises of:
searching a predetermined space of potential programs' executions for one that produces the observed output; and
wherein searching includes using symbolic reasoning to infer values of non-deterministic accesses of target execution
wherein the symbolic reasoning includes reasoning done with the aid of an automated symbolic reasoning program (e.g., constraint solver or theorem prover)
wherein the non-deterministic accesses include those of racing instruction accesses
wherein the predetermined space of potential executions includes only those executions likely to exhibit the observed output behaviors
wherein executions likely to exhibit the observed output behaviors includes those executions that exhibit all observed behaviors
extracting essential state for the future reproduction of the reconstructed execution;
wherein essential state includes the inferred values of non-deterministic accesses

22. A method according to claim 18, where the analyzing of the reconstructed program's behaviors comprises of:
re-running the reconstructed executions; and
analyzing the re-run with tracing tools;
wherein tracing tools include debuggers, race detectors, memory leak detectors, and causality tracers.
